(19) United States
(12) Patent Application Publication
(10) Pub. No.: US 2012/0034981 A1
(43) Pub. Date: Feb. 9, 2012

(54) Game system, game system control method and storage medium

(75) Inventor: Tsuyoshi Yamaguchi, Minato-Ku (JP)

(73) Assignee: Konami Digital Entertainment Co., Ltd., Tokyo (JP)

(21) Appl. No.: 13/136,440

(22) Filed: Aug. 1, 2011

(30) Foreign Application Priority Data
Aug. 6, 2010 (JP) 2010-177285

(51) Int. Cl. A63F 9/24; A63F 13/00

(52) U.S. Cl. 463/42; 463/43

(57) ABSTRACT

Characters involved in an actual match during the match are extracted, a team strength value indicating a strength level of each team is calculated for each team based on ability values of the extracted characters, and a difference between the calculated team strength values of the respective teams is calculated. When the team having a lower team strength value than the opponent wins the match, a privilege corresponding to the difference between the team strength values is granted to this team.

### BACKGROUND OF THE INVENTION AND RELATED ART STATEMENT

1. Field of the Invention

The present invention relates to a game system for causing a computer to realize a team match game in which players respectively operating a plurality of terminal units compete by maneuvering characters constituting their own teams, a method for controlling this game system and a storage medium.

2 Description of the Related Art

In recent years, with faster data transfer rate in Internet connection, network games have spread in which a plurality of terminal units are communicably connected via the Internet and players operating the respective terminal units compete against each other. Personal computers, home game machines and the like are used as the terminal units. Match-up type network games of this type include team match games in which players compete while maneuvering a plurality of characters constituting their own teams. Various games such as baseball games and soccer games exist.

Match-up type network games as described above are realized by a game system including a plurality of terminal units and a server apparatus respectively connected to a network. Normally, players utilizing the game system operate the terminal units and log into the server apparatus by operating the terminal units, thereby incorporating the terminal units into the game system. Then, the server apparatus performs a matching process for determining a combination of opponents out of the plurality of terminal units that are logged in. After the combination of opponents is determined by the server apparatus, a network game is played by the determined terminal units directly transmitting and receiving data to and from each other.

In some of game systems for executing the above match-up type network game, game results may be collected by the server apparatus and the ranking of the players (ranking of the teams operated by the players) may be calculated by the server apparatus based on game performances of the respective players. In this case, the players can attain a higher ranking as they win more match games. For example, JP2005-21712 discloses a technology for evaluating abilities of respective players based on a ranking difference between opponents and a match results (victory and defeat). In this literature, evaluation given when a player with a lower ranking wins against a player with a higher ranking is set to be relatively high.

The above ranking indicates the levels of the players' skills, but does not necessarily indicate strengths of the teams in the team match game. This is because each team is composed of a plurality of characters and, if the player changes a team composition (changes the characters constituting the team), substantial team strength changes according to an ability value of the changed character. Particularly, in the team match game, the ability values of the respective characters constituting the team have a profound effect on the evaluation of the team strength.

In the case of a match by a combination of teams, the team strengths (team levels) of which are largely different, a heated game development cannot be expected and the game may become uninteresting. Accordingly, in a matching process in the team match game, a team strength value (team level value) may be calculated by totaling the ability values of all the player characters belonging to each team, the calculated team strength values of the respective teams may be compared and the teams having close team strength values may be matched. For example, in a baseball game, one team is normally composed of 28 player characters. Thus, the matching process is performed using a total value of the ability values of 28 player characters as the team strength value. In this way, the players with the team compositions having close team strength values are likely to be matched up so that the game can be made more interesting and enjoyable.

However, even in such a case, the following problems have occurred.

For example, when each player arbitrarily selects player characters within the range of player selection enabling points given according to the level of the player beforehand and organizes his own baseball team (28 player characters), 9 player characters with very high abilities may be collected and the remaining 19 player characters may be set to have very low abilities depending on the player. In actual games, there are cases where a game is played using only nine player characters with very high abilities. In such cases, 19 player characters with very low abilities are used only to lower an apparent team strength value. On the other hand, many of ordinary players normally organize their own baseball teams by selecting player characters in a well-balanced manner and play the game while thinking team strategies such as replacement of player characters.

In the above case, although the game system matches the players having comparable team strength values, the ability values of the actually competing player characters may largely differ and the ordinary player having organized the team in a normal manner may feel a sense of injustice, which causes a reduced interest in the game.

### SUMMARY OF THE INVENTION

In view of the above problem, an object of the present invention is to provide a game system for realizing a more interesting and enjoyable team match game by appropriately judging team strengths in an actual match and correcting a sense of injustice of players, a method for controlling this game system and a storage medium.

One aspect of the present invention is directed to a game system for executing a team match game in which players compete respectively operating a plurality of terminal units compete by maneuvering characters constituting own teams, comprising an involved character extracting unit for extracting characters involved in an actual match during the match; a team strength calculating unit for calculating a team strength value indicating a strength level of each team for each team based on ability values of the characters extracted by the involved character extracting unit; a strength difference calculating unit for calculating a difference between the team strength values of the respective teams calculated by the team strength calculating unit; and a privilege granting unit for granting a privilege corresponding to the difference between the team strength values calculated by the strength difference calculating unit to the winning team when the team having a lower team strength value than the opponent wins the match.

Another aspect of the present invention is directed to a method for controlling a game system for executing a team match game in which players respectively operating a plurality of terminal units compete by maneuvering characters constituting own teams, comprising an involved character extracting step in which the game system extracts characters involved in an actual match during the match; a team strength calculating in which the game system calculates a team strength value indicating a strength level of each team for each team based on ability values of the characters extracted in the involved character extracting step; a strength difference calculating step in which the game system calculates a difference between the team strength values of the respective teams calculated in the team strength calculating step; and a privilege granting step in which the game system grants a privilege corresponding to the difference between the team strength values calculated in the strength difference calculating step to the winning team when the team having a lower team strength value than the opponent wins the match.

Still another aspect of the present invention is directed to a computer-readable storage medium storing a program for causing a computer included in a game system for executing a team match game in which players respectively operating a plurality of terminal units compete by maneuvering characters constituting own teams to realize an involved character extracting function of extracting characters involved in an actual match during the match; a team strength calculating function of calculating a team strength value indicating a strength level of each team for each team based on ability values of the characters extracted by the involved character extracting function; a strength difference calculating function of calculating a difference between the team strength values of the respective teams calculated by the team strength calculating function; and a privilege granting function of granting a privilege corresponding to the difference between the team strength values calculated by the strength difference calculating function to the winning team when the team having a lower team strength value than the opponent wins the match.

These and other objects, features and advantages of the present invention will become more apparent from an embodiment described with reference to accompanying drawing.

### BRIEF DESCRIPTION OF THE DRAWING

FIG. 1 is a diagram showing the entire construction of a game system according to one embodiment of the invention,

FIG. 2 is a diagram showing the hardware construction of each terminal unit constituting the game system according to the embodiment of the invention,

FIG. 3 is a functional block diagram of a control unit of a server apparatus constituting the game system according to the embodiment of the invention,

FIG. 4 is a functional block diagram showing an example of a control unit in each terminal unit constituting the game system according to the embodiment of the invention,

FIG. 5 is a flow chart showing main operations of the game system according to the embodiment of the invention,

FIG. 6 is a flow chart showing main operations of each terminal unit constituting the game system according to the embodiment of the invention,

FIG. 7 is a flow chart showing exemplary main operations of the server apparatus constituting the game system according to the embodiment of the invention,

FIG. 8 is a functional block diagram showing another example of the control unit in each terminal unit constituting the game system according to the embodiment of the invention,

FIG. 9 is a functional block diagram showing a construction example of an essential part of the control unit in each terminal unit constituting the game system according to the embodiment of the invention,

FIG. 10 is a functional block diagram showing another construction example of the essential part of the control unit in each terminal unit constituting the game system according to the embodiment of the invention,

FIG. 11 is a functional block diagram showing still another construction example of the essential part of the control unit in each terminal unit constituting the game system according to the embodiment of the invention,

FIG. 12 is a functional block diagram showing further another construction example of the essential part of the control unit in each terminal unit constituting the game system according to the embodiment of the invention, and

FIG. 13 is a functional block diagram showing a construction example of a privilege granting unit in the server apparatus constituting the game system according to the embodiment of the invention,

### DETAILED DESCRIPTION OF THE PREFERRED EMBODIMENTS OF THE INVENTION

The invention is now described, by way of example, with reference to the accompanying drawings.

### [Overall Construction of the Network Game System]

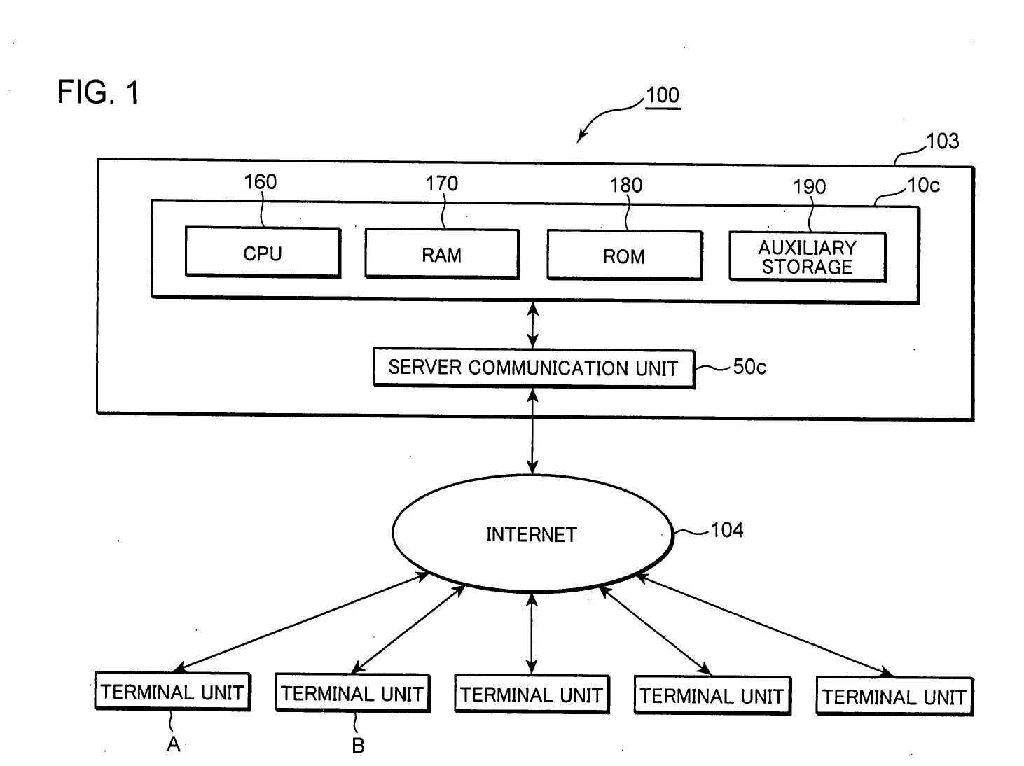

FIG. 1 is a diagram showing the entire construction of a network game system 100. As shown in FIG. 1, the network game system 100 capable of executing a team match-up type network game according to this embodiment is provided with a server apparatus 103 and a plurality of terminal units including a terminal unit A and a terminal unit B communicably connected to the server apparatus 103. These apparatuses (server apparatus 103 and the plurality of terminal units) are connected via Internet 104 as a communication network.

Note that the plurality of terminal units are present in the network game system 100 and have the same basic construction. The terminal unit A and the terminal unit B (these are collectively written as “terminal units A, B” if necessary) are described as representatives of the plurality of terminal units in the network game system 100.

The communication network of this embodiment is not limited to the Internet and may be, for example, a dedicated line, a public line, a LAN or the like or may be a combination of these provided that it is capable of communicably connecting the terminal units A, B and the server apparatus 103 to each other.

The terminal units A, B operated by respective players participating in the team match-up type network game executable by this network game system 100 are known home game machines, mobile game machines, personal digital assistants, mobile phones, personal computers or the like. Methods for competing between the terminal units A, B operated by the respective players include a method for competing through direct communication between the terminal units A, B and a method for competing via the server apparatus 103. A game can be played by either method, but a network game is executed by the former method, i.e. through so-called P2P (Peer to Peer) connection for direct data communication between the terminal units A, B in this embodiment.

Communication between the respective terminal units A, B and the server apparatus 103 is carried out by using a HTTP (Hyper Text Transfer Protocol) which operates on, for example, a TCP/IP (Transmission Control Protocol/Internet Protocol) as a base protocol and implementing an application protocol specified by this system at a higher level.

On the other hand, communication between the P2P-connected terminal unit A and terminal unit B can be realized by a UDP (User Datagram Protocol) which is a communication protocol on an OSI reference model transport layer and mainly implemented on an IP protocol. Since the above UDP is a communication method which merely transmits data to another terminal unit without performing any data transmission confirmation and error correction, data reliability is low, but there is an advantage of high data transfer rate. Thus, in a communication match-up type network game in which mutual communication of a large amount of data at a high speed is carried out in a game environment requiring a high real-time property, the UDP is suitably used. Note that it is, of course, possible to use an existing protocol other than the UDP for communication between the terminal unit A and the terminal unit B and to use a new protocol to be newly specified in the future.

In the network game system 100, terminal IDs used to uniquely identify the respective terminal units A, B are assigned to the respective terminal units A, B. Further, player IDs used to specify the respective players are assigned to the respective players who operate the respective terminal units A, B. The server apparatus 103 transmits and receives data to and from the respective terminal units A, B in correspondence with these pieces of identification information (terminal IDs and player IDs), thereby managing information on the respective terminal units A, B and the respective players and performing an opponent determining process (matching process), a match-up management process and a privilege granting process to be described later.

There are various team match-up type network games realized by the network game system 100 and a baseball game is one example. In this baseball game, there is also a manager play mode in which players compete as managers. In this manager play mode, the respective players can arbitrarily select player characters within the range of player selection enabling points given according to player levels in advance and organize their own baseball teams (e.g. a total of 28 player characters). In a baseball game in which a first team organized by a first player who operates the terminal unit A and a second team organized by a second player who operates the terminal unit B compete, for example, a pitcher character of the team of the first player throws a ball object and a batter character of the team of the second player hits the thrown ball object. Further, a fielder character of the team of the first player catches and throws the hit ball object, and a runner character of the team of the second player runs to the first base. The baseball game in which the first and second players compete for points while changing offense and defense by applying general baseball rules in this way is described as an example below.

### [Construction of Each Apparatus in Network Game System]

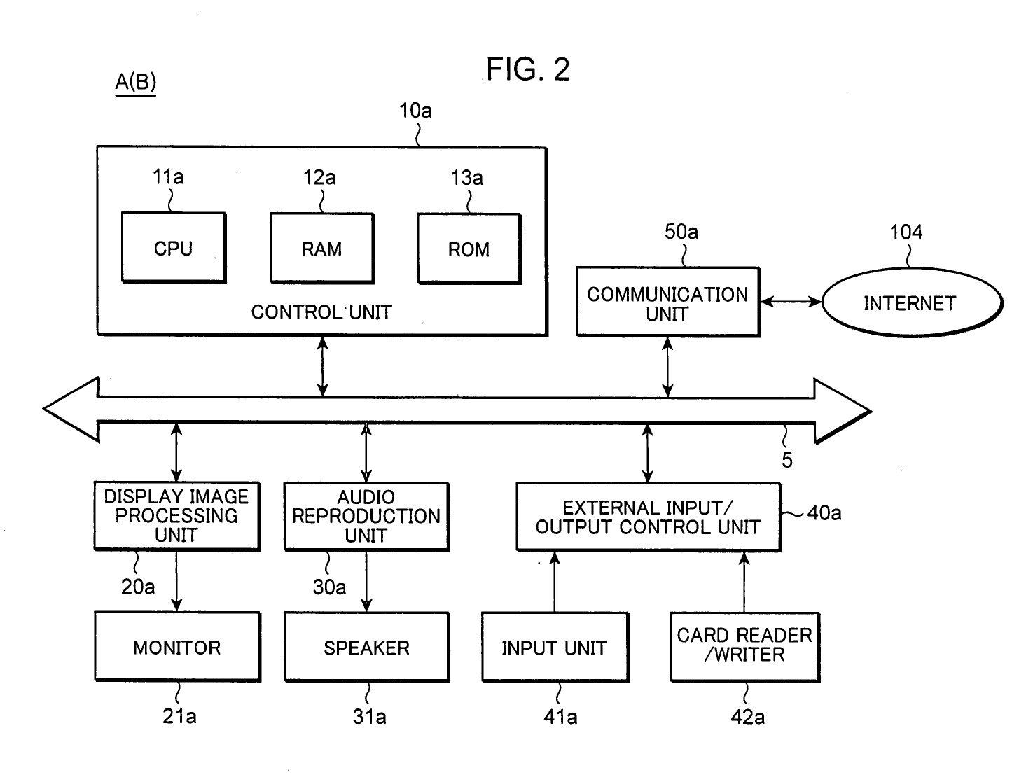

As shown in FIG. 2, the terminal unit A includes a control unit 10a, a display image processing unit 20a, an audio reproduction unit 30a, an external input/output control unit 40a and a communication unit 50a. These are connected to each other by a bus 5. Since the terminal unit B is constructed similar to the terminal unit A, only the construction of the terminal unit A is described below without describing the terminal unit B.

As shown in FIG. 2, the control unit 10a controls the overall operation of the terminal unit A and includes an information processor (CPU) 11a for performing various information processings in addition to an image display processing, a RAM (Random Access Memory) 12a for temporarily storing information and the like being processed and a ROM 13a storing various programs and the like beforehand. These are connected to each other via the bus 5.

Program data of an operation system (OS), game data including image data, audio data and various program data, and other data are recorded in the ROM 13a. Image data recorded in the ROM 13a include data of pitcher characters, batter characters, fielder characters, runner characters, background images, images of various operation screens and setting screens, and the like. Further, image data such as the pitcher characters and the batter characters are made up of a specified number of polygons so as to enable three-dimensional imaging.

The CPU 11a reads the image data, the audio data, the control program data, the game program data and other data from the ROM 13a based on the operating system recorded in the built-in or detachable ROM 13a. Part or all of the read data are retained on the RAM 12a. Thereafter, the CPU 11a performs various data processings based on the control program and various data (image data including polygons, textures of objects to be displayed and other character image, audio data, etc.) stored on the RAM 12a.

The above data processings include a calculation processing on a three-dimensional space, a position transformation calculation processing from the three-dimensional space to a pseudo three-dimensional space, a light source calculation processing and an image and audio data generation processing, and the like.

Out of various data stored in the ROM 13a, data that can be stored in a detachable storage medium may be readable, for example, by various drive units such as a hard disk drive, an optical disk drive, a flexible disk drive and a cassette medium reader. In this case, a hard disk, an optical disk (CD-ROM, DVD-ROM, UMD, etc.), a flexible disk, a semiconductor memory, a ROM cassette, a cartridge for home video game machine, or the like may be used as the storage medium.

The display image processing unit 20a includes an interface circuit, a D/A converter (Digital-to-Analog converter) and the like and displays image data written in the RAM 12a, image data read from the ROM 13a and other data on a monitor 21a such as a liquid crystal display.

The audio reproduction unit 30a generates audio messages, sound effects, music data and the like to be given as the game progresses and outputs them to a speaker 31a in accordance with an instruction from the CPU 11a.

The external input/output control unit 40a includes an interface circuit and the like and controls data input and output between the control unit 10a and an input unit 41a or between the control unit 10a and a card reader/writer 42a. For example, the external input/output control unit 40a converts an operation detection signal input from the input unit 41a into a digital signal processable in the control unit 10a. The input unit 41a is composed of a keyboard, a mouse, a controller for home video game machine and the like used by the first player to enter various operation commands.

The communication unit 50a includes a communication information interface circuit, a communication modem and the like and transmits and receives various data to and from the server apparatus 103 and to and from the terminal unit B of the opponent via the Internet 104.

Next, the construction of the server apparatus 103 is described. As shown in FIG. 1, the server apparatus 103 is a computer including a server control unit 10c and a server communication unit 50c.

The server control unit 10c controls the overall operation of the server apparatus 103 and includes an information processor (CPU) 160, a RAM for temporarily storing information and the like being processed, a ROM 180 storing a specified program and the like beforehand, and an auxiliary storage 190 such as a hard disk device or an optical disk device. An operation system (OS), various programs and various setting data recorded in the ROM 180 and the auxiliary storage 190 are loaded onto the RAM 170 and the programs on the RAM 170 are successively implemented by the CPU 160, whereby various functions of the server apparatus 103 are realized.

The server control unit 50c includes a communication information interface circuit, a communication modem and the like and transmits and receives various data to and from the terminal units including the terminal units A, B via the Internet 104.

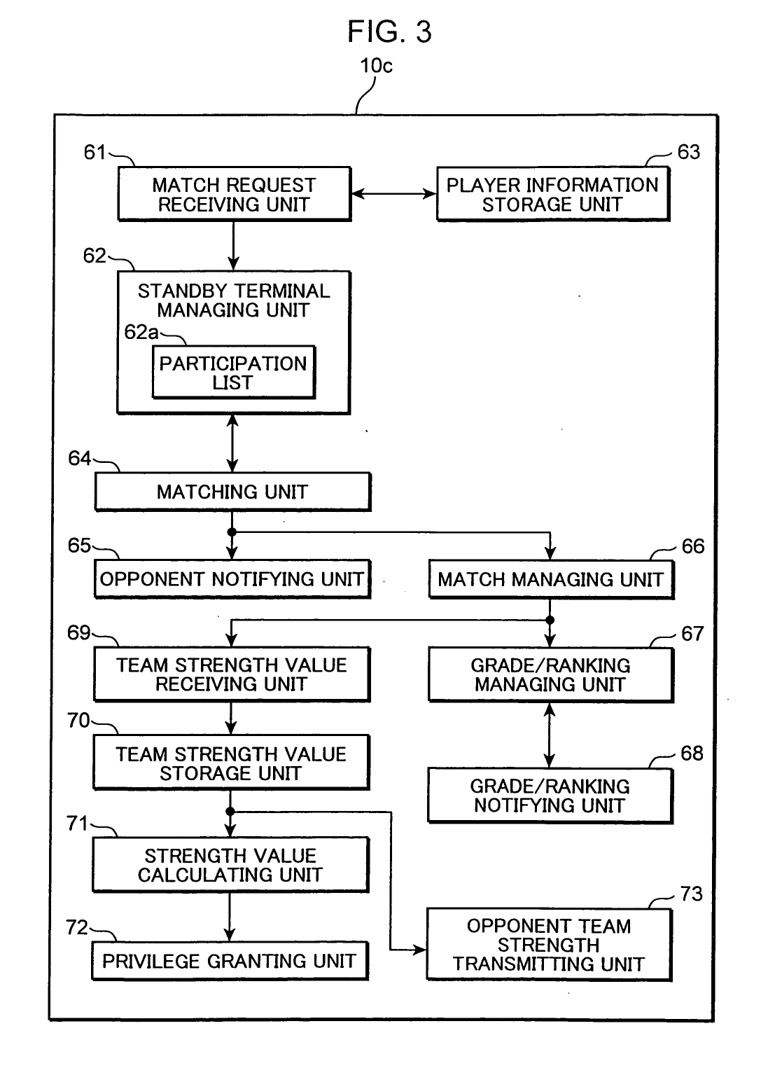

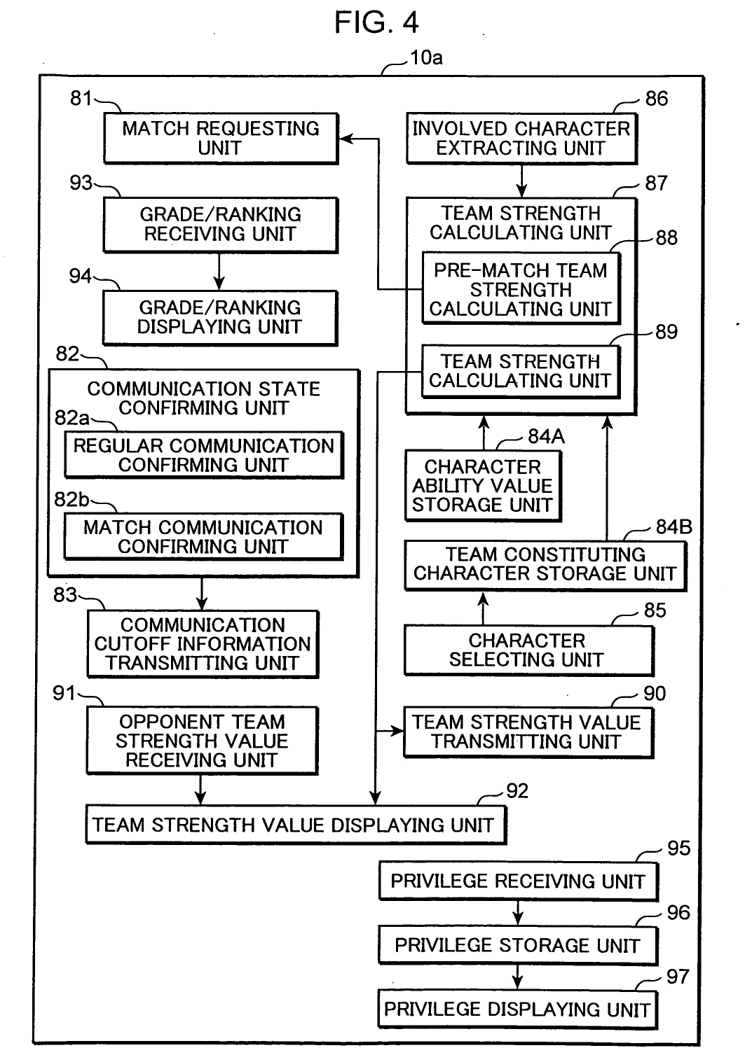

Next, the functional constructions of the terminal units A, B and the server apparatus 103 are described below. FIG. 3 is a functional block diagram of the server control unit 10c in the server apparatus 103. FIG. 4 is a functional block diagram of the control unit 10a in the terminal unit A and the terminal unit B.

First, main functions of the server apparatus 103 are described. The server apparatus 103 has a login authentication function, a matching function, a grade/ranking management function, a privilege granting function and other functions.

The login authentication function is a function of judging whether or not each player has qualification to participate in a communication match-up type network game and performing login authentication when players wishing to participate in the game attempt to log into the server apparatus 103 by operating the respective terminal units A, B. For example, in the case of a members-only online service game, member authentication is performed.

The above matching function is a function of determining a combination of opponents out of a match requesting terminal group made up of a plurality of terminal units requesting a match.

The above grade/ranking management function is a function of cumulatively evaluating game performances of the respective players up to date, determining grades (may also be virtual rewards, honors, classes and the like) and rankings (world rankings, national rankings, rankings in a specified area, and the like) as ability evaluation levels to be granted to the respective players, and managing these grades and rankings while relating them to identification information (terminal IDs and player IDs) of the respective terminal units A, B.

The above privilege granting function is a function of granting a privilege corresponding to a difference in team strength to the player of a winning team when a team judged to have a lower team strength than the opponent wins a match. Assignment of points and in-game coins usable in the game, an increase in a degree of increasing the ability of each player character at the time of victory and throwaway game, increases in the types and numbers of items usable in the game, and various other things are thought as examples of the privilege.

Since the above login authentication function, matching function, grade/ranking management function and privilege granting function may be realized anywhere in the network game system 100, they need not necessarily be realized in one server apparatus 103. For example, some of these functions may be separated and realized as a plurality of functionally-distributed servers. In this embodiment, a construction example in which these functions are all possessed and centrally managed by the server apparatus 103 is described for the sake of convenience.

As shown in FIG. 3, the server control unit 10c of the server apparatus 103 includes a match request receiving unit 61, a standby terminal managing unit 62, a player information storage unit 63, a matching unit 64, an opponent notifying unit 65, a match managing unit 66, a grade/ranking managing unit 67, a grade/ranking notifying unit 68, a team strength value receiving unit 69, a team strength value storage unit 70, a strength difference calculating unit 71, a privilege granting unit 72 and an opponent team strength transmitting unit 73.

The match request receiving unit 61 receives the identification information (individual information such as terminal IDs and player IDs) of the respective terminal units A, B when players wishing to participate in the network game attempt to log into the server apparatus 103 by operating the respective terminal units A, B. Then, the match request receiving unit 61 cross-checks the terminal IDs and the player IDs and receives participation of the respective players in the game based on player information stored in the player information storage unit 63, i.e. performs the above login authentication function.

The standby terminal managing unit 62 manages the terminal units A, B, the participation of which was received, as a match requesting terminal group until a combination of opponents is determined by registering the match requesting terminal group in a participation list 62a. The match requesting terminals registered in the participation list 62a are to be matched up by the matching unit 64.

The player information storage unit 63 stores terminal IDs and player IDs as player information based on which participation in the network game can be received.

The matching unit 64 realizes the above matching function and performs a matching process for determining a combination of opponents from the match requesting terminal group registered in the participation list 62a. Various methods can be adopted for the matching process by the matching unit 64. In this embodiment, a method for matching up the teams based on strength values (pre-match team strength values) of teams organized by the respective players by the matching unit 64 is described as an example. Here, the pre-match team strength value is a total value (or an average value) of ability values of all 28 player characters in a team made up of 28 player characters organized by each player. That is, which player characters the respective players use in a match are not determined yet before the match. Thus, the ability values of all 28 player characters constituting the team are totaled (or averaged) to set the pre-match team strength value. In this method, the matching unit 64 matches the players having the teams, the pre-match team strength values of which are close, out of the match requesting terminal group registered in the participation list 62a. If players having teams, the pre-match team strength values of which are largely different, compete against each other, a heated game development cannot be expected and the game may become uninteresting. Accordingly, if the above matching method is applied, the players having the teams, the pre-match team strength values of which are close, are likely to be matched up, whereby the game can be made more interesting and enjoyable.

The opponent notifying unit 65 notifies information on the opponents to a first terminal unit (hereinafter, described as the terminal unit A) and a second terminal unit (hereinafter, described as the terminal unit B) matched up by the matching unit 64. That is, the opponent notifying unit 65 extracts information on a second player of the terminal unit B as an opponent from the player information storage unit 63 and transmits it to the terminal unit A. Further, the opponent notifying unit 65 extracts information on a first player of the terminal unit A as an opponent from the player information storage unit 63 and transmits it to the terminal unit B.

The match managing unit 66 manages states of communication of the both terminal units A, B until the match game ends when the match game between the terminal units A and B is played. Specifically, the terminal unit A and the terminal unit B intermittently transmit regular data (heartbeats) to the server apparatus 103 while playing the match game through P2P connection, and the match managing unit 66 of the server apparatus 103 judges that the both terminal units A, B are playing the match game while receiving the heartbeats from the both terminal units A, B. On the other hand, the match managing unit 66 judges that communication with the terminal unit, which was transmitting the heartbeat, has been cut off when being unable to receive the heartbeat for a predetermined time (e.g. 10 seconds). For example, if reception of the heartbeat from the terminal unit A has been terminated, but the heartbeat from the terminal unit B is still being received, the match managing unit 66 can judge that the terminal unit A has cut off communication during the match. In such a case, abnormal end notification to the effect that “terminal unit A has cut off communication during the match” is given from the terminal unit B to the server apparatus 103. Thus, it can be reliably judged with this abnormal end notification that the terminal unit A cut off communication during the match.

If the match game normally ends, normal end notification including match result information (information on victory and defeat) is given to the server apparatus 103 from either one or both of the terminal unit A and the terminal unit B. The match managing unit 66 takes the terminal unit A and the terminal unit B off a group of terminal units to be matched up when receiving this normal end notification or the above abnormal end notification. Note that reception of the heartbeats from the terminal unit A and the terminal unit B may be simultaneously terminated in the case of a network failure such as abnormal convergence of the network due to an increase in traffic. Also in such a case, the match managing unit 66 can take the both terminal units A, B off the group of terminal units to be matched up. After the end of the match, the match managing unit 66 outputs match result information to the grade/ranking managing unit 67 and the team strength value receiving unit 69.

The grade/ranking managing unit 67 realizes the above grade/ranking management function, includes a storage area in which information on the grades and rankings of the respective players is stored in relation to the identification information (terminal IDs and player IDs) of the terminal units, and updates the grades and rankings of the respective players based on the match result information every time the match game ends.

The grade/ranking notifying unit 68 has a function of transmitting the grades and rankings after the end of the match to the terminal unit A and the terminal unit B. This enables the first player of the terminal unit A and the second player of the terminal unit B to confirm their own grades and rankings after the end of the match on a screen. Further, the grade/ranking managing unit 67 or the grade/ranking notifying unit 68 may have a function of enabling the player, who ranked high in the ranking, to register information such as the name of the player.

The team strength value receiving unit 69 receives the team strength values transmitted from the terminal units A, B after the end of the match and outputs them to the team strength value storage unit 70. This team strength value received after the end of the match is a strength level of each team calculated based on the ability values of only the player characters actually involved in the match. Here, actual involvement in the match means that the player character got to bat, pitched, took to the field or ran to the base, and substitute player characters that only sat on the bench and did not participate in the match at all or those that were replaced midway through the match and had no chance of offense and defense for more than predetermined innings are excluded. The pre-match team strength value described above is not based only on the player characters actually involved in the match, but based on all the player characters constituting the team, and largely differs from the team strength value transmitted from the terminal units A, B after the end of the match. Note that detailed calculation of the team strength value performed in the terminal units A, B is described later.

The team strength value storage unit 70 includes a storage area in which the team strength values received from the terminal units A, B by the team strength value receiving unit 69 are stored in relation to the identification information (terminal IDs and player IDs) of the players.

The strength difference calculating unit 71 reads the team strength values of the both teams having competed from the team strength value storage unit 70, calculates a difference between the team strength values and outputs a calculation result to the privilege granting unit 72.

The privilege granting unit 72 grants a privilege corresponding to the difference between the team strength values calculated in the strength difference calculating unit 71 to the player of the winning team if the team having a lower team strength than the opponent won. For example, the privilege granting unit 72 calculates points or in-game coins usable in the game according to the difference between the team strength values and transmits grant information (privilege information) on the calculated points or the like to the terminal unit of the team that won the match despite having the lower team strength value than the opponent. The terminal unit having received this privilege information from the server apparatus 103 validates the privilege information, whereby the player can attain the points or in-game coins usable in the game. The above privilege information may be information which increases a degree of increasing the abilities of the player characters (growth degree), information which increases the types or numbers of items usable in the game, or other information which is advantageous and useful to the player in the game.

Note that the privilege granting unit 72 may grant a privilege corresponding to the difference between the team strength values calculated in the strength difference calculating unit 71 to the player of the team also if the team having the lower team strength than the opponent managed a draw in the match.

The opponent team strength transmitting unit 73 transmits the team strength value of the opponent team to each terminal unit, i.e. has a function of transmitting the team strength value of the team of the terminal unit B to the terminal unit A and transmitting the team strength value of the team of the terminal unit A to the terminal unit B. Thus, the first player of the terminal unit A and the second player of the terminal unit B can confirm not only the team strength values of their own teams, but also those of the opponent team on the screen after the end of the match.

Since this team strength value is calculated based on only the player characters actually involved in the match, each player can know an accurate strength level of each team corresponding to the real match (fact).

Next, main functions of the terminal units A, B are described. As shown in FIG. 4, the control unit 10a of each of the terminal units A, B includes a match requesting unit 81, a communication state confirming unit 82, a communication cutoff information transmitting unit 83, a character ability value storage unit 84A, a team constituting character storage unit 84B, a character selecting unit 85, a player character extracting unit 86, a team strength calculating unit 87, a team strength value transmitting unit 90, an opponent team strength value receiving unit 91, a team strength value displaying unit 92, a grade/ranking receiving unit 93, a grade/ranking displaying unit 94, a privilege receiving unit 95, a privilege storage unit 96 and a privilege displaying unit 97.

The match requesting unit 81 has a login function of transmitting the identification information (terminal ID and player ID) of the terminal unit to the server apparatus 103 and requesting participation in the network game. Further, the match requesting unit 81 also transmits information on a pre-match team strength value calculated in a pre-match team strength calculating unit 88 to be described later together with the identification information and the like to the server apparatus 103.

The communication state confirming unit 82 confirms a state of communication with the server apparatus 103 and with the opponent terminal unit and includes a regular communication state confirming unit 82a and a match communication state confirming unit 82b. The regular communication state confirming unit 82a confirms whether or not regular communication with the server apparatus 103 is established while transmitting regular data (heartbeat) to the server apparatus 103 at every specified time interval (e.g. every 10 seconds) after connection to the server apparatus 103. The match communication state confirming unit 82b confirms whether or not match communication with the opponent terminal unit is established while detecting a state of data transmission and reception to and from the opponent terminal unit during the match game.

For example, considering a case where communication of the terminal unit A is cut off for a certain cause during a match between the first player of the terminal unit A and the second player of the terminal unit B, whether or not the regular communication with the server apparatus 103 and the terminal unit B is established is confirmed by the regular communication state confirming unit 82a and it is confirmed by the match communication state confirming unit 82b that the match communication between the terminal units A and B has been cut off in the terminal unit B. In this way, the communication state confirming unit 82 of the terminal unit B detects that the communication of the opponent terminal unit (terminal unit A) has been cut off during the match.

The communication cutoff information transmitting unit 83 gives abnormal end notification to the server apparatus 103 by transmitting communication cutoff information to the effect that the opponent terminal unit has cut off communication during the match to the server apparatus 103 if it is detected by the communication state confirming unit 82 that the opponent terminal unit has cut off the communication during the match.

The character ability value storage unit 84A stores the ability values of the respective player characters in correspondence with identification information (character IDs) individually identifying all the player characters present in the game in a storage area of a nonvolatile storage medium such as a hard disk or a memory card. Here, the higher the ability value of the player character, the higher the abilities (batting skill, defensive skill, running skill, etc.) of the player character in the game.

The team constituting character storage unit 84B stores identification information (character IDs) of a plurality of player characters constituting a team selected by the player using the character selecting unit 85 in the storage area of the nonvolatile storage medium such as a hard disk or a memory card.

The character selecting unit 85 is used by the player to select player characters constituting an own team in a manager play mode in which the player competes against an opponent team as a manager. For example, the player characters can be displayed as images on a game screen in the form of cards enabling visual confirmation so that the player can grasp visually and with a sense of presence which player characters are selected to organize a team. In this case, the character selecting unit 85 enables selection of the player characters (28 player characters in one team in this embodiment) by a specified button operation, pointing unit operation or the like by the input unit 41a on a list display screen of the player characters displayed in the form of cards. The identification information of 28 player characters selected by the character selecting unit 85 is stored in the team constituting character storage unit 84B. Note that 28 player characters belonging to the team organized for the last match are stored in the team constituting character storage unit 84B. Thus, in the team organization for the match this time, the stored player characters may be read and displayed as images and only some of the player characters to be changed (substituted) may be selected and changed using the character selecting unit 85.

The involved character extracting unit 86 has a function of extracting the player characters of the own team actually involved in the match during the match. Specifically, in the case of offense, the involved character extracting unit 86 extracts the player characters, which actually got to bat for offense, as player characters involved in the actual game and successively store the identification information of the extracted player characters in a specified storage area of the RAM 12a, a hard disk, a memory card or the like. Further, the involved character extracting unit 86 may extract a player character, which did not get to bat, but got on base as a pinch runner, as a player character involved in the actual game.

However, if a player character, who got to bat as a pinch hitter, is replaced by another player character after being struck out looking a ball object thrown by a pitcher character several times without swinging a bat even once, this player character as a pitch hitter is not necessarily thought to have gotten involved in the actual match although it got to bat. Thus, this player character may not be extracted as the player character involved in the actual match. In the case of offense, only the player characters involved in the actual match may be extracted until the result of at least one at-bat (any one of results of hit, out and bases on balls plus hit batsman) is given. Alternatively, only the player characters involved in the offense for a predetermined number of or more at-bats may be extracted.

Further, the involved character extracting unit 86 extracts the player characters, which actually took to the field, as player characters involved in the actual match and stores the identification information of the extracted player characters in a specified storage area of the RAM 12a, a hard disk, a memory card or the like in the case of defense.

If a player character, which took to the field as a substitute, is replaced by another player character again in a short time without having even one chance of defensive action, the player character that took to the field is not necessarily thought to have gotten involved in the actual match. Thus, this player character may not be extracted as the player character involved in the actual match. Accordingly, in the case of defense, only player characters having a chance of defensive action for at least a predetermined number of or more innings may be extracted. Here, the player characters having a chance of defensive action may be the player characters that touched a ball object such as by catching a hit ball object or the like, but may include the player character located at a predetermined distance from a trajectory of the ball object although not directly touching the ball object. That is, the player character that caught the hit ball object, the one that touched the ball object, but could not catch the ball object by the globe, and the one that tried to catch the ball object by stretching the arm since being located near the trajectory of the ball object, but could not touch the ball object can be the player characters having a chance of defensive action. In other words, characters having touched a target object playing a central role in the progress of a game (ball object in ball games such as baseball and soccer) or characters located at a predetermined distance from the trajectory of the target object can be characters directly involved in a match.

In this way, the involved character extracting unit 86 extracts the player characters involved in the actual match during the match excluding the substitute player characters that only sat on the bench and did not participate in the match at all and those that were replaced midway and did not have a chance of offense and defense of a predetermined degree although belonging to the own team. The involved character extracting unit 86 successively extracts the identification information of the player characters involved in the actual match and stores it from the start to the end of the match, and outputs the identification information of all the player characters stored when the match ends to the team strength calculating unit 87.

The team strength calculating unit 87 includes the pre-match team strength calculating unit 88 and a team strength calculating unit 89. The pre-match team strength calculating unit 88 calculates a total value (or average value) of the ability values of 28 player characters in a team made up of 28 player characters and organized by each player as the pre-match team strength value. As described above, which player characters each player actually uses in the match are not determined yet before the match. Thus, the pre-match team strength value is calculated by totaling (or averaging) the ability values of all the player characters of the team. The pre-match team strength value calculated by pre-match team strength calculating unit 88 is transmitted to the server apparatus 103 via the match requesting unit 81 and used for matching to determine an opponent.

The team strength calculating unit 89 calculates a team strength value indicating a strength level of the own team based on the ability values of the player characters involved in the actual match extracted by the involved character extracting unit 86. Specifically, the team strength calculating unit 87 calculates an average of the ability values of a plurality of player characters extracted by the involved character extracting unit 86 and sets the calculated average value as the team strength value of the own team. The team strength calculating unit 89 outputs the calculated team strength value of the own team to the team strength value transmitting unit 90 and the team strength value displaying unit 92.

The team strength value transmitting unit 90 has a function of transmitting the team strength value of the own team calculated by the team strength calculating unit 89 to the server apparatus 103. The team strength value transmitted to the server apparatus 103 is used for the privilege granting process corresponding to the difference between the team strength values of the teams having competed as described above.

The opponent team strength value receiving unit 91 receives the team strength value of the opponent transmitted from the server apparatus 103 after the end of the match and outputs it to the team strength value displaying unit 92. Although the team strength value of the opponent is received from the server apparatus 103 in this embodiment, it may be received from the terminal unit of the opponent.

The team strength value displaying unit 92 displays the team strength value of the own team calculated in the team strength calculating unit 89 and the team strength value of the opponent received by the opponent team strength value receiving unit 91 on the monitor 21a. This enables the player to confirm the team strength values of the own team and the opponent team for the player characters involved in the actual match and compare the levels of the both teams truly reflecting real match facts.

The grade/ranking receiving unit 93 receives grade information and ranking information transmitted from the server apparatus 103 at the time of logging into the server apparatus 103 or ending a match. The grade/ranking displaying unit 94 displays the present grade and ranking of the player on the monitor 21a based on the grade information and ranking information received by the grade/ranking receiving unit 93.

The privilege receiving unit 95 receives privilege information (points, in-game coils or the like usable in the game described above) transmitted from the server apparatus 103 and outputs it to the privilege storage unit 96. As described above, a privilege is granted when a team having a lower team strength than the opponent wins a match. The privilege storage unit 96 stores the privilege information received by the privilege receiving unit 95 in the storage area of the nonvolatile storage medium such as a hard disk or a memory card. The privilege is validated by storing the privilege information in this privilege storage unit 96 and the player can enjoy the privilege (e.g. can attain and use the points or in-game coins usable in the game). Further, when the privilege is validated by storing the privilege information in the privilege storage unit 96, the privilege displaying unit 97 displays the content of the privilege on the monitor 21a, thereby enabling the player to recognize that the privilege has been granted.

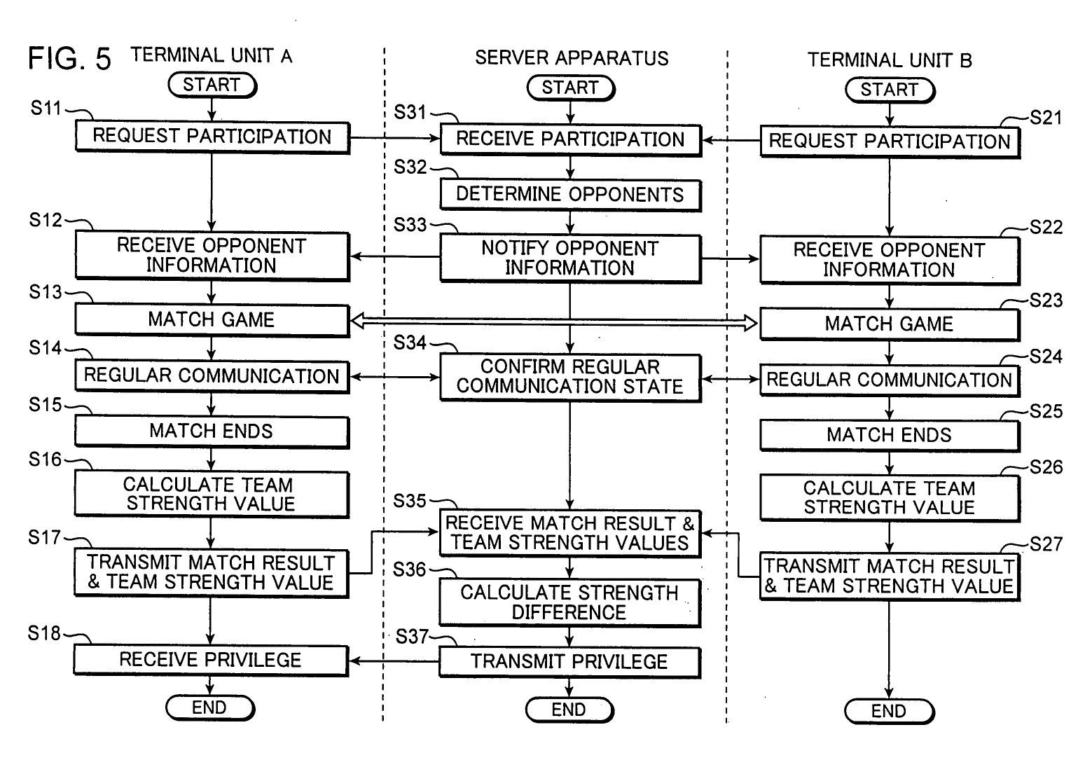

Next, a summary of operations of the network game system 100 according to this embodiment is described with reference to a flow chart shown in FIG. 5. The flow chart of FIG. 5 shows an operation example assuming a case where the terminal unit A and the terminal unit B log into the network game system 100 to participate in the network game, the both terminal units A, B are matched up and the team of the terminal unit A having a lower team strength than the team of the terminal unit B wins a match.

To participate in the network game, the respective players need to incorporate the terminal units into the network game system 100. Accordingly, after setting conditions by operating the terminal unit A, the first player requests participation in the network game (login) to the server apparatus 103 (S11). Similarly, after setting various conditions by operating the terminal unit B, the second player requests participation in the network game (login) to the server apparatus 103 (S21). Here, the terminal units A, B respectively transmit the pre-match team strength values calculated for all the player characters constituting the own teams to the server apparatus 103 at the time of login.

The server apparatus 103 having received participation requests from the respective terminal units A, B receives participation of the respective terminal units A, B in the network game after performing login authentication (S31). Thereafter, the server apparatus 103 performs the matching process to determine a combination of opponents from a match requesting terminal group made up of a plurality of terminal units requesting a match (S32). In this matching, the terminal units of the teams, the pre-match team strength values of which are close, are combined. Here, description continues, assuming that the terminal unit A and the terminal unit B are matched up. The server apparatus 103 notifies opponent information to the matched terminal unit A and terminal unit B (S33).

When the terminal unit A receives the opponent information from the server apparatus 103 (S12) and the terminal unit B receives the opponent information from the server apparatus 103 (S22), the both terminal units A, B can be connected to each other by P2P and start a match game (S13 and S23).

The respective terminal units A, B also perform regular communication to transmit regular data (heartbeats) to the server apparatus 103 during the match game (S14 and S24). Then, the server apparatus 103 confirms states of regular communication with the respective terminal units A, B by receiving the heartbeats from the respective terminal units A, B (S34). In this way, the server apparatus 103 can confirm that the terminal units A, B are competing.

Thereafter, when the team match between the terminal units A, B ends (S15 and S25), the respective terminal units A, B calculate the team strength values indicating the strength levels of the own teams based on the ability values of the player characters for only the player characters involved in the actual match (S16 and S26).

Thereafter, the respective terminal units A, B transmit the match result and the team strength values of the own teams to the server apparatus 103 (S17 and S27). Then, the server apparatus 103 receives the match result and the team strength values from the respective terminal units A, B (S35) and calculates a difference between the team strength values of the both teams (S36) when the team having a lower team strength value won against the team having a higher team strength value. Since here is assumed the case where the team of the terminal unit A having the lower team strength value than the team of the terminal unit B won the match, the server apparatus 103 generates privilege information corresponding to the difference between the team strength values of the both teams and transmits the privilege information to the terminal unit A to grant a privilege to the first player of the terminal unit A (S37). The terminal unit A receives the privilege information from the server apparatus 103 (S18), whereby the first player of the terminal unit A attains the privilege useable in the game or the like.

Next, main operations of the respective terminal units executing a baseball game are described. Here, the operations of the terminal unit A as a representative are described.

When a baseball game start button is pressed in the terminal unit A, a game program stored in the ROM 13a or a storage medium is loaded into the RAM 12a and stored. At this time, various basic game data necessary to execute the baseball game are also loaded from the ROM 13a or the storage medium and stored in the RAM 12a. In this way, the game program and the basic game data are recognized by the CPU 11a of the terminal unit A. Here, the basic game data include data on various images for a three-dimensional game space (e.g. image data of a baseball stadium, image data of respective player characters, image data of various objects, etc.) and position coordinate data used to arrange data on various images for the three-dimensional game space in the three-dimensional game space. The basis game data also include information on ability values of the respective player characters.

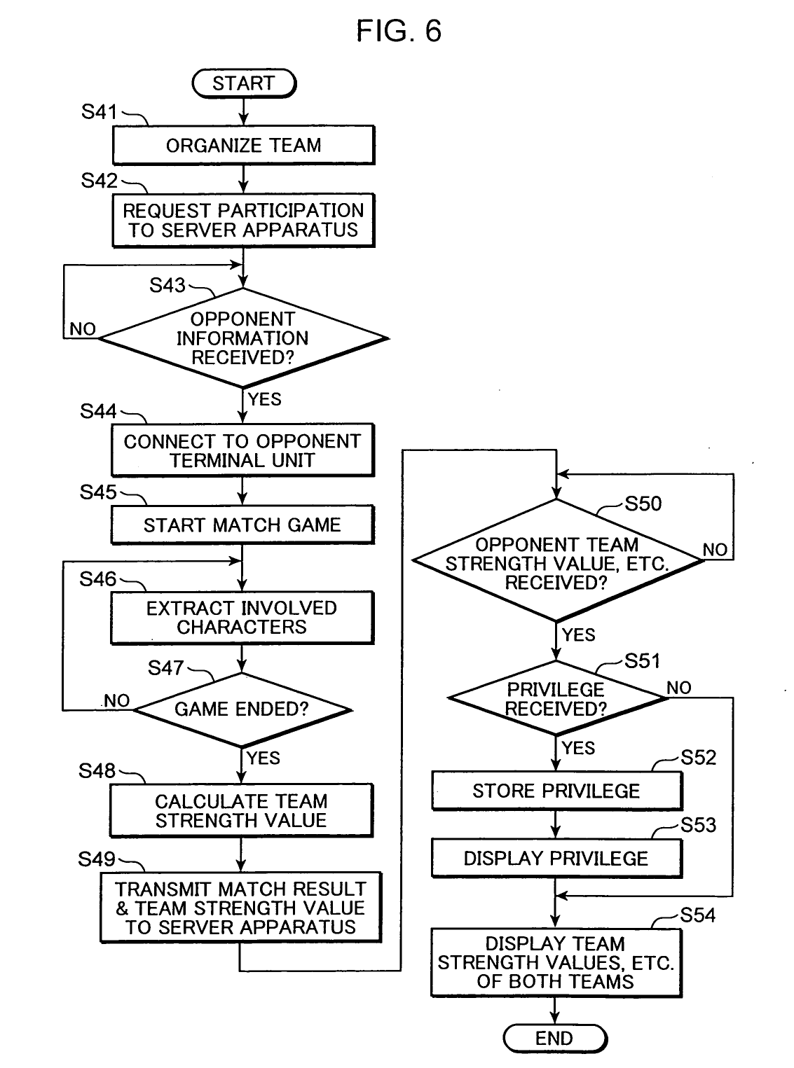

Subsequently, the CPU 11a of the terminal unit A implements the game program based on the basic game data stored in the RAM 12a. Normally, an initial screen is displayed on the monitor 21a when a baseball game program is started, thereby enabling various settings to execute the baseball game. For example, if the baseball game has a plurality of play modes, a play mode selection screen for selecting a play mode is displayed on the monitor 21a. On this play mode selection screen, the player can select a play mode by operating the input unit 41a. Prepared play modes include, for example, a manager player mode in which the player collects player characters to organize his own team and competes as a manager, a match mode in which the player selects a specific team from 12 baseball clubs (or 30 baseball clubs in the case of a Major League game) and enjoys one match, a pennant mode in which a specific team is selected from 12 baseball clubs for a pennant race, a growth experience mode in which the player experiences a baseball game as one player character, and the like. Note that one player can play a baseball game through an automatic control by the CPU based on an AI (Artificial Intelligence) program, but it is assumed here that the manager play mode by Internet match playing was selected and the following description continues with reference to a flow chart shown in FIG. 6.

After selecting the manager play mode by Internet match playing, the player selects a specified number of (here, 28) player characters and organizes his own team using the character selecting unit 85 (S41). At this time, the player may select the player characters within the range of player selection enabling points possessed by him. Here, the player selection enabling points are in-game points which can be attained by the player such as in the case of winning a match during the game. The higher the ability value of the player character is, the more player selection enabling points are required. Thus, the player organizes a team by selecting the player characters within the frame of the player selection enabling points in view of the player selection enabling points possessed by him and the ability values of the respective player characters. Information on the player characters selected by the player (character IDs) is stored in the team constituting character storage unit 84B. Further, the pre-match team strength calculating unit 88 of the terminal unit A calculates the pre-match team strength value by totaling (or averaging) the ability values of all 28 selected player characters.

Subsequently, the player requests participation (login) to the server apparatus 103 by operating the terminal unit A (S42). In S42, the match requesting unit 81 of the terminal unit A (see FIG. 4) transmits the identification information (terminal ID and player ID) of the terminal unit A, the pre-match team strength value and the like to the server apparatus 103.

Thereafter, the terminal unit A waits until receiving opponent information from the server apparatus 103 (S43). Then, after receiving the opponent information from the server apparatus 103 (YES in S43), the terminal unit A is connected to the opponent terminal unit by P2P (S44) and starts a match game with the opponent terminal unit (S45). During the match game, the communication state confirming unit 82 of the terminal unit A transmits regular data to the server apparatus 103.

Further, during the match game, the involved character extracting unit 86 of the terminal unit A extracts the player characters of the own team involved in the actual match and stores the identification information of the extracted player characters in the specified storage area (S46).

When the baseball game with predetermined innings ends (YES in S47), the team strength calculating unit 89 of the terminal unit A calculates the team strength value based on the ability values of a plurality of player characters involved in the actual match extracted by the involved character extracting unit 86 (S48).

Thereafter, the team strength value transmitting unit 90 of the terminal unit A transmits match result information (information on victory and defeat) and the team strength value of the own team calculated by the team strength calculating unit 89 to the server apparatus 103 (S49).

Thereafter, the terminal unit A waits until receiving information on the team strength value, grade and ranking of the opponent team transmitted form the server apparatus 103 and, when the terminal unit A receives the strength value and the like of the opponent team (YES in S50) and when the terminal unit A also receives the privilege information (YES in S51), the privilege storage unit 96 stores this privilege information in the specified storage area (S52). Here, the terminal unit A receives the privilege information from the server apparatus 103 when the own team won the match despite having a lower team strength value than the opponent (privilege may be granted also in the case of a draw). The privilege is validated by storing the privilege information in the privilege storage unit 96.

Thereafter, the privilege displaying unit 97 of the terminal unit A enables the player to confirm the grant of the privilege by displaying the content of the privilege on the monitor 21a (S53) and the team strength value displaying unit 92 and the grade/ranking displaying unit 94 display the team strength values, grades and rankings of the own team and the opponent team on the monitor 21a (S54).

On the other hand, if the team strength value of the own team was higher than the opponent and/or if the own team lost the match, the team strength values, grades and rankings of the own team and the opponent team are displayed on the monitor 21a of the terminal unit A (S54) without the terminal unit A receiving the privilege information from the server apparatus 103 (NO in S51).

Although a combination of opponents is determined on the condition that pre-match team strength values are close (a difference between pre-match team strength values of both teams is in a predetermined range) in the matching in the server apparatus 103, there may be a big difference between abilities of the competing teams, depending on player characters actually used during the match. As described above, this becomes conspicuous in a match between a player who collects 9 player characters with very high abilities, sets the abilities of the remaining 19 player characters to be very low and competes while using only 9 player characters with very high abilities during an actual match and an ordinary player who organizes his own baseball team by selecting player characters in a well-balanced manner and plays while thinking team strategies such as replacement of player characters during the match.

In this embodiment, regardless of whether a privilege is to be granted or not, the team strength values of the own team and the opponent team calculated based only on the player characters actually involved in the match can be confirmed on the monitor 21a after the match ends and the players can accurately recognize the strengths of the opponent teams against which their teams competed.

As a system, it has caused a sense of injustice among players that levels of player characters largely differ in an actual match although opponents having comparable team levels are matched up based on pre-match team strength values. However, in this embodiment, a privilege corresponding to a difference between team strength values of both teams having competed against each other is granted when an own team wins a match despite having a lower team strength value than the opponent team. Thus, a sense of injustice can be resolved.

Particularly, for level comparison of the both teams having competed against each other, the team strength values calculated based only on the player characters actually involved in the match are used and the privilege corresponding to the difference between the team strength values is granted. Thus, the strength of the opponent team against which the player actually competed is truly reflected on the privilege. Accordingly, the player can confirm a big privilege granted when winning against the opponent he actually felt strong during the game and, hence, can feel convinced. Further, since the player practically has a chance to attain a higher privilege for a stronger opponent, concentration on a game to attain a higher privilege is aroused. Therefore, it is possible to realize a game which strongly attracts players into a virtual space.

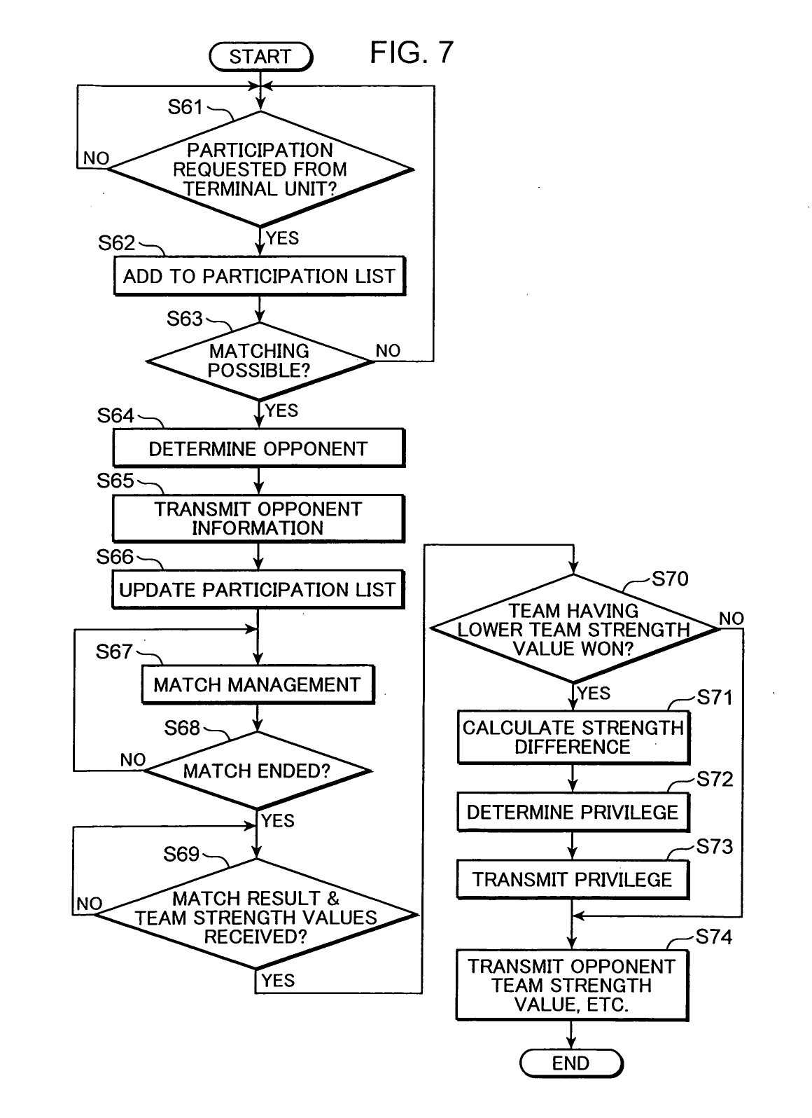

Next, main operations of the server apparatus 103 are described with reference to a flow chart shown in FIG. 7.

When receiving a participation request from the terminal unit of a player wising to participate in a network game (YES in S61), the server apparatus 103 receives participation of this terminal unit after performing login authentication and adds information of this terminal unit to the participation list 62a (S62). The information of the terminal unit registered in the participation list 62a includes identification information (terminal ID and player ID), a pre-match team strength value and the like of the terminal unit. Processings in S61 and S62 are performed by the match request receiving unit 61 and the standby terminal managing unit 62 shown in FIG. 3.

For example, when no matching can be made yet such as when there is only one terminal unit registered in the participation list 62a (NO in S63), a routine of S61 to S63 is repeated to add information of terminal units to the participation list 62a. When matching becomes possible (YES in S63), the server apparatus 103 selects one specific terminal unit from a match requesting terminal group registered in the participation list 62a (selects the terminal unit earliest registered in the participation list 62a). Then, the matching unit 64 of the server apparatus 103 determines a terminal unit having a pre-match team strength value, which differs from the pre-match team strength value of the selected one terminal unit by a value lying in a predetermined range, as an opponent (S64).

Thereafter, the opponent notifying unit 65 of the server apparatus 103 transmits information of the respective opponents to the respective matched terminal units (S65).

Thereafter, the server apparatus 103 deletes the both terminal units, the matching of which was completed, from the participation list 62a and updates the participation list 62a by adding a new terminal unit having requested participation in the network game to the participation list 62a (S66).

After matching, the server apparatus 103 manages and monitors a state during the match by intermittently receiving the regular data from the both terminal units competing against each other (S67). After the match ends (YES in S68), the server apparatus 103 receives a match result and the team strength values from the both terminal units having competed against each other (YES in S69).

Thereafter, the privilege granting unit 72 of the server apparatus 103 judges whether or not the team having a lower team strength value than the opponent won the match (S70). If YES in S70, the server apparatus 103 proceeds to S71 after judging that a privilege is to be granted to the player of the terminal unit of the winning team.

In S71, the strength difference calculating unit 71 of the server apparatus 103 calculates a difference between the team strength values of the both teams having competed against each other (S71). Then, the privilege granting unit 72 of the server apparatus 103 determines a privilege corresponding to the difference between the team strength values (S72). Here, a case where points usable in the game are granted as a bonus is described below as an example of the privilege.

If Twin denotes a team strength value of a winning team, Tlost denotes that of a losing team and P denotes bonus points granted as the privilege, the bonus points P can be calculated, for example, by the following equation (1).

P=(Tlost−Twin)×100+300 (1)

In the above equation (1), the difference between the team strength values (Tlost−Twin) is multiplied by 100 and base points of 300 are added thereto. For example, if Twin=14, Tlost=15 and the team having a lower team strength value won the match, bonus points P are 400 points according to the above equation (1).

Further, bonus points may be granted in consideration of a point spread as a match result of the both teams. For example, if Swin denotes the score of the winning team and Slost denotes the score of the losing team, bonus points P may be calculated by the following equation (2).

P={(Tlost−Twin)×100+300}×{1.0+(Swin−Slost)×0.2} (2)

In the above equation (2), a rate {1.0+(Swin−Slost)×0.2} corresponding to the score spread (Swin−Slost) is multiplied. For example, if Twin=14, Tlost=15 and the team having a lower team strength value won by a score of “5−3” (Swin=5, Slost=3), bonus points P are 560 points according to the above equation (2).

In this way, the privilege granting unit 72 increases the privilege granted as a score spread of the match result increases, whereby more concentration on the match is aroused to attain a higher privilege.

After the privilege to be granted is determined in S72, the privilege granting unit 72 of the server apparatus 103 transmits privilege information to the terminal unit of the team that won the match despite having the lower team strength value than the opponent (S73).

Further, the opponent team strength transmitting unit 73 and the grade/ranking notifying unit 68 of the server apparatus 103 transmit information on the team strength value, grade and ranking of the opponent team to each of the terminal units having competed against each other (S74).

On the other hand, unless the team having the lower team strength value than the opponent won the match (NO in S70), the server apparatus 103 proceeds to S74 without performing the bonus granting process.

Although the example of granting the privilege when the team having the lower team strength value than the opponent won the match is described above, a privilege corresponding to the difference between the team strength values of the both teams having competed against each other may be given to the player of the team having the lower team strength than the opponent when this team managed a draw in the match. If Tlow denotes the team strength value of a team having a lower team strength value and Thigh denotes that of a team having a higher team strength value, bonus points in an example of this case can be calculated by the following equation (3) with a rate of 0.5.

P{(Thigh−Tlow)×100+300}×0.5 (3)

The privilege is basically granted when a team having a lower team strength value than the opponent won (or managed a draw) the match. If a difference between team strength values of both teams is not very large (if this difference is smaller than a predetermined value), it may be designed to grant a smaller privilege when the team having a higher team strength value than the opponent wins (or manages a draw) than when the team having a lower team strength value than the opponent wins (or manages a draw). Also in this case, the above equations (1) to (3) can be applied (however, the calculated bonus points P are treated as 0 (zero) when being negative).

For example, if a case is assumed where Twin=15, Tlost=14 and the team having the higher team strength value than the opponent won the match, bonus points P are P=(14−15)×100+300=200 (points) according to the above equation (1) and lower than 400 points when Twin=14 and Tlost=15.

Further, if Twin=15, Tlost=14 and the team having the higher team strength value than the opponent won by a score of “5−3” (Swin=5, Slost=3), bonus points P are P={(14−15)×100+300}×{1.0+(5−3)33 0.2}=280 (points) according to the above equation (2) and lower than 560 points when Twin=14 and Tlost=15.

Further, if Twin=15, Tlost=14 and the match ended in a draw, bonus points P of the team having the lower team strength value are P={(15−14)×100+300}×0.5=200 (points) and bonus points P of the team having the higher team strength value are P={(14−15)×100+300}×0.5=100 (points) according to the above equation (3).

Concerning bonus points P granted to a team having a higher team strength value, the bonus points P are 0 or less if a difference between team strength values of both teams (Tlost−Twin) or (Thigh−Tlow) is equal to 3 or more according to the above equations (1) to (3). Thus, a privilege is granted only when a difference between team strength values is below 3.

### [Other Construction Example of the Game System]

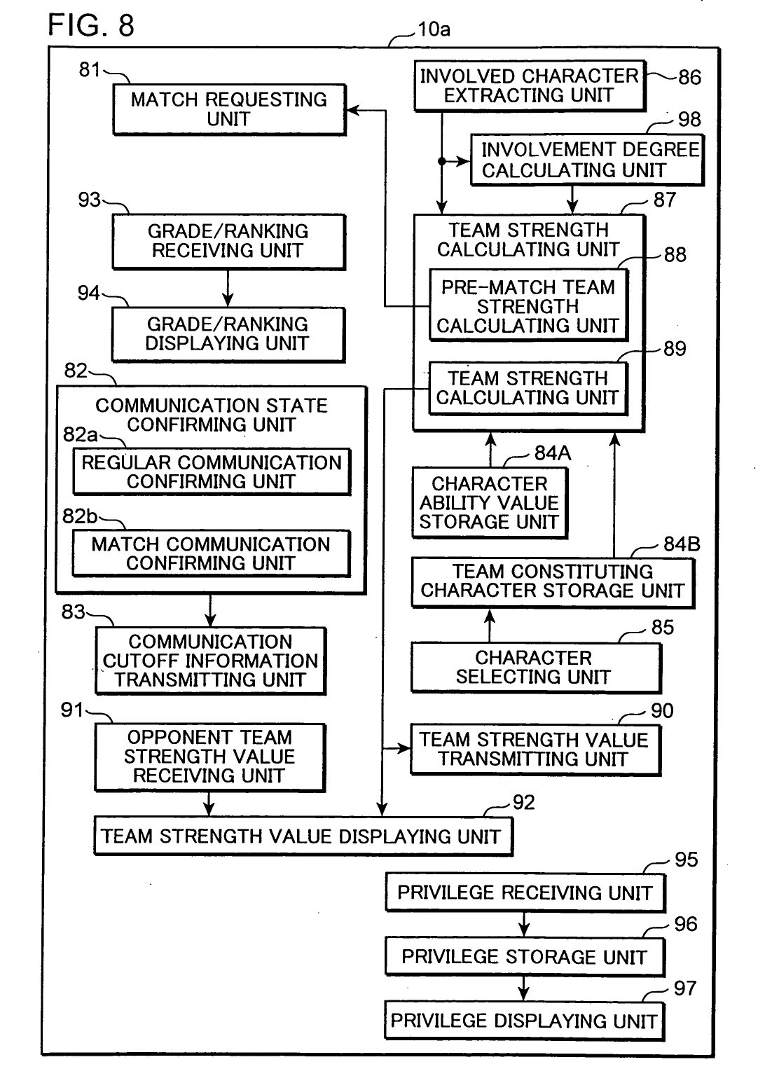

Next, a modification of the control unit 10a of the terminal unit shown in FIG. 4 is described below with reference to a functional block diagram shown in FIG. 8. Note that elements similar to those shown in FIG. 4, etc. are identified by the same reference numerals and not described.

Since degrees of involvement in a match of the respective player characters involved in an actual match differ, a construction example shown in FIG. 8 further includes an involvement degree calculating unit 98 for calculating a degree of involvement in a match of each character extracted by the involved character extracting unit 86, and the team strength calculating unit 87 calculates a team strength value by increasing a weight of an ability value of each player character as the degree of involvement in the match of each player character calculated by the involvement degree calculating unit 98 increases. The other construction in the terminal unit is the same as that shown in FIG. 4 and the construction and operations of the server apparatus 103 are also as described above.

An example of calculating a degree of involvement of each character in the involvement degree calculating unit 98 is described below.

In the case of offense in a baseball game, all of 9 batters do not always get to bat the same number of times. If another character goes to bat in place of a certain player character (e.g. pitcher character) as a pinch hitter, for example, in an excellent opportunity to score, the at-bat of this player character is finished. Further, the player character, which participated as a pinch hitter during the match, got to bat less frequently than the other player characters that participated in all the innings. In this way, the player characters that were replaced midway through the game during the match and entered the game midway have lower degrees of involvement in the match than the other player characters that played in all the innings, as a matter of course.

Also in the case of defense in the baseball game, the player characters that were replaced midway through the game during the match and entered the game midway have a lower chance of defense than the other player characters that played in all the innings, it can be said that they have lower degrees of involvement in the match.

Accordingly, the involvement degree calculating unit 98 can increase the degree of involvement for the player character that played in more innings. Specifically, if Iall denotes a total inning number of the game, leach denotes a play inning number of each player character and X denotes a degree of involvement in the match of each player character, the degree of involvement X can be calculated by X=Ieach/Iall.

Since the time length differs in each inning, the involvement degree calculating unit 98 may calculate the degree of involvement in the match of each player character based on a game playing time instead of the inning number. Specifically, if Tall denotes a game time from the start to the end of the game, Teach denotes a game playing time of each player character and X denotes a degree of involvement in the match of each player character, the degree of involvement X can be calculated by X=Teach/Tall.

If offensive innings and defensive innings are temporally completely separated as in the baseball game, degrees of involvement in the case of offense and those in the case of defense may be separately calculated. For example, the involvement degree calculating unit 98 increases the degree of involvement for the player character that got to bat more frequently in the case of offense in the baseball game. Specifically, if Ball denotes the total number of at-bats of the team, Beach denotes the number of at-bats of each player character and Xattack denotes a degree of involvement in offense of each player character, the degree of involvement Xattack can be calculated by Xattack=Beach/Ball. In this way, a degree of involvement in proportion to the number of at-bats of each player character can be calculated.

Further, in the case of defense in the baseball game, degrees of importance of a pitcher character and a catcher character leading the pitcher character in the game are larger than those of the other fielder characters. Accordingly, the involvement degree calculating unit 98 decreases a degree of involvement Xdefense in defense in the order of <degree of involvement of the pitcher character>, <degree of involvement of the catcher character> and those of the other fielder characters in the case of defense in the baseball game. For example, the degree of involvement of the pitch character can be 45%, that of the catcher character can be 20% and those of the remaining 7 fielder characters can be respectively 5% (total of 35%). Further, also in consideration of defense inning number and time of each player character, the degree of involvement Xdefense in defense of each player character may be calculated.

The team strength calculating unit 87 calculates the team strength value while increasing a weight of the ability value of each player character as the degree of involvement in the match of each player character calculated by the involvement degree calculating unit 98 increases. That is, the team strength calculating unit 87 may multiply the ability value of each player character by a weight in proportion to the degree of involvement in the match of each player character and calculate the team strength value by taking a weighted average.

In the case of separately calculating the degree of involvement Xattack in offense and the degree of involvement Xdefense in defense of each player character as described above, the team strength calculating unit 87 can calculate the team strength value in the case of offense (team strength value at the time of offense) and the team strength value in the case of defense (team strength value at the time of defense) respectively and can set the sum or average of these as the team strength value.

Particularly, in the case of separately calculating the degree of involvement Xattack in offense and the degree of involvement Xdefense in defense of each player character, it is preferable to store the ability value of each player character in the character ability value storage unit 84A in the form of two separate ability values, i.e. an offensive skill (ability value at the time of offense, batting skill and the like in the case of baseball) and a defensive skill (ability value at the time of defense). Then, the team strength calculating unit 87 uses the degree of involvement Xattack in offense and the ability value at the time of offense of each player character in the calculation of the team strength value in the case of offense and uses the degree of involvement Xdefense in defense and the ability value at the time of defense of each player character in the calculation of the team strength value in the case of defense. In this way, the team strength value accurately reflecting the offensive skill and defensive skill of each player character can be calculated.

As described above, the construction example shown in FIG. 8 further includes the involvement degree calculating unit 98 for calculating a degree of involvement in the match of each character extracted by the involved character extracting unit 86, and the team strength calculating unit 87 calculates the team strength value by increasing the weight of the ability value of each player character as the degree of involvement in the match of each player character calculated by the involvement degree calculating unit 98 increases. Thus, the team strength value reflecting also the degree of involvement in the match of each player character involved in the actual match can be obtained and the team levels of the both teams truly reflecting the real match facts can be compared. Since the privilege is granted according to the difference between the team strength values, the strength of the opponent team against which the player actually competed can be more truly reflected on the privilege.

### [Still Another Construction Example of the Game System]

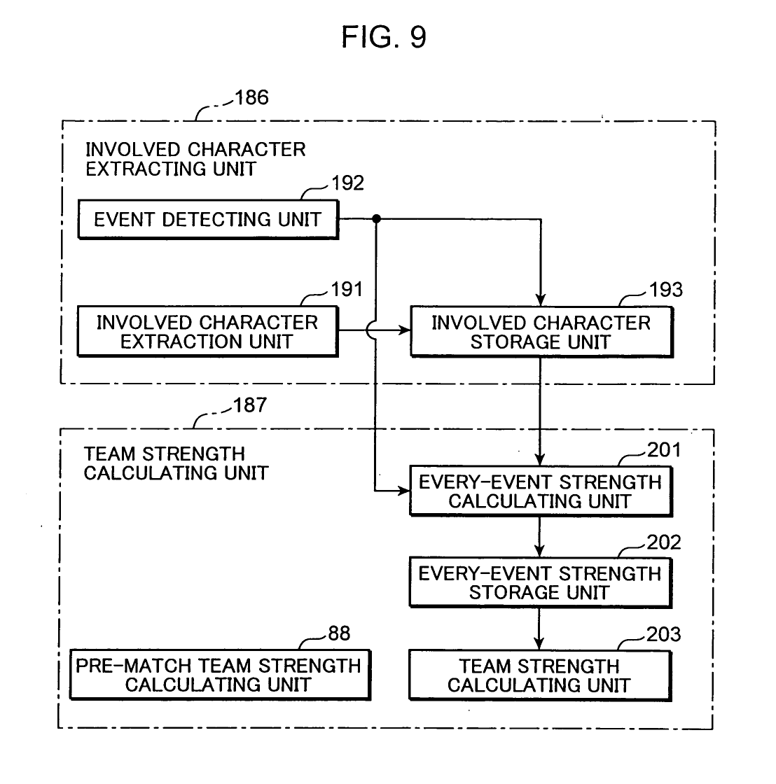

Next, a modification of the control unit 10a of the terminal unit shown in FIG. 4 is described below with reference to a functional block diagram shown in FIG. 9. Note that elements similar to those shown in FIG. 4, etc. are identified by the same reference numerals and not described.

In this construction example, the involved character extracting unit 86 and the team strength calculating unit 87 in the control unit 10a of the terminal unit shown in FIG. 4 are replaced by an involved character extracting unit 186 and a team strength calculating unit 187 shown in FIG. 9. The other construction of the terminal unit is the same as that shown in FIG. 4 and the construction and operations of the server apparatus 103 are also as described above.

In this construction example, player characters involved in an actual match are extracted in every specified event (e.g. in every at-bat) constituting the match, a strength value in every specified invent is calculated as needed based on the ability values of the extracted player characters, and a team strength value is calculated by averaging the strength values in every specified event when the match ends.

In a baseball game, every specified event constituting the match may be every throw of a ball from a pitcher character, every at-bat (every time a result (out, hit, bases on balls plus hit batsman) for one batter is given), every out, every half inning (every three outs), every inning (including first and second half innings), or the like. For example, in a soccer game, every specified event constituting the match may be every pass, every shot, every time a ball object crosses a touch line or goal line, or the like. Various events can be adopted as the specified event constituting the match depending on the type of the game. In this embodiment, every at-bat in the baseball game is described below as an example of every specified event constituting the match.

As shown in FIG. 9, the involved character extracting unit 186 includes an involved character extraction unit 191, an event detecting unit 192 and an involved character storage unit 193.

The involved character extraction unit 191 has a function of extracting player characters involved in an actual match and performs an operation similar to that of the involved character extracting unit 86. Identification information of the player characters extracted by the involved character extraction unit 191 is stored in the involved character storage unit 193.

The event detecting unit 192 has a function of outputting a detection signal in every specified event. In this embodiment, the event detecting unit 192 outputs a detection signal to the involved character storage unit 193 and an every-event strength calculating unit 201 to be described later in every at-bat where a result (out, hit, bases on balls plus hit batsman) is given for one batter. Here, an end timing of one at-bat where the result for one batter is given is a timing at which a series of plays in one at-bat such as hitting of a ball character thrown by a pitcher character by a batter character and, as a result, catching of the ball character by a fielder character end. For example, if a batter character hits a ground ball to third with the bases empty, one at-bat ends when a third baseman character catches the ball character and throws it to the first baseman character and the first baseman character catches the ball character to determine an out. For example, if a batter character hits a single to left with the bases empty, one at-bat ends when a left fielder character catches the ball character and returns it to infield (returns it to a second baseman character playing near the second base). In the case of offense with runners) on the base(s), more fielder characters may catch, throw and do other actions. The inventor detecting unit 192 detects the end of these series of plays and outputs a detection signal.

The involved character storage unit 193 stores identification information of the player characters extracted by the involved character extraction unit 191 in a specified storage area. Further, the involved character storage unit 193 outputs the information on the player characters in one at-bat to the every-event strength calculating unit 201 to be described later every time a detection signal is input from the event detecting unit 192, and clears the storage area after the output. That is, the involved character storage unit 193 constantly stores the information on the player characters involved in the match in the last at-bat.

An example of the player characters extracted by the involved character extraction unit 191 from the start to the end of the play in one at-bat is illustrated below. For example, if it is assumed that there was a hit over shortstop with a runner on the first base, the player characters involved in the play in this at-bat are as follows.

Defense side: pitcher character, catcher character, left fielder character (catch and throw), shortstop character (when being located at a predetermined distance from a trajectory of a hit ball character), third baseman character (when the ball character is returned from the left fielder character to the third baseman character to prevent further advance of the runner), first baseman character (when there is a pickoff throw from the pitcher character to the runner character)

Offense side: batter character, runner character (running from the first base to the second base)

Next, the team strength calculating unit 187 is described. The team strength calculating unit 187 includes the every-event strength calculating unit 201, an every-event strength storage unit 202, a team strength calculating unit 203 and an already described pre-match team strength calculating unit 88.

To the every-event strength calculating unit 201 are input a detection signal from the event detecting unit 192 in every at-bat and the information on the player characters involved in the match in every at-bat from the involved character storage unit 193. The every-event strength calculating unit 201 calculates a strength value in every at-bat based on the information on the player characters involved in the match in every at-bat received from the involved character storage unit 193 and stores it in the every-event strength storage unit 202. The strength value in every at-bat can be calculated as an average value of the ability values of the player characters involved in the plays in one at-bat. The every-event strength calculating unit 201 repeats an operation of calculating the strength value in every at-bat as needed and storing it in the every-event strength storage unit 202 from the start to the end of the game.

Here, the ability value of each player character can be stored as two separate ability values, i.e. an offensive skill (ability value at the time of offense) and a defensive skill (ability value at the time of defense, in the character ability value storage unit 84A. Then, the every-event strength calculating unit 201 may use the ability values of the respective player characters at the time of offense in the calculation of the strength value in the case of offense and use the ability values of the respective player characters at the time of defense in the calculation of the strength value in the case of defense.

The every-event strength storage unit 202 stores the strength value in every at-bat calculated by the every-event strength calculating unit 201 in a specified storage area. This every-event strength storage unit 202 stores all the strength values in every at-bat calculated by the every-event strength calculating unit 201 from the start to the end of the match.

The team strength calculating unit 203 calculates a team strength value by averaging all the strength values in every at-bat stored in the every-event strength storage unit 202.

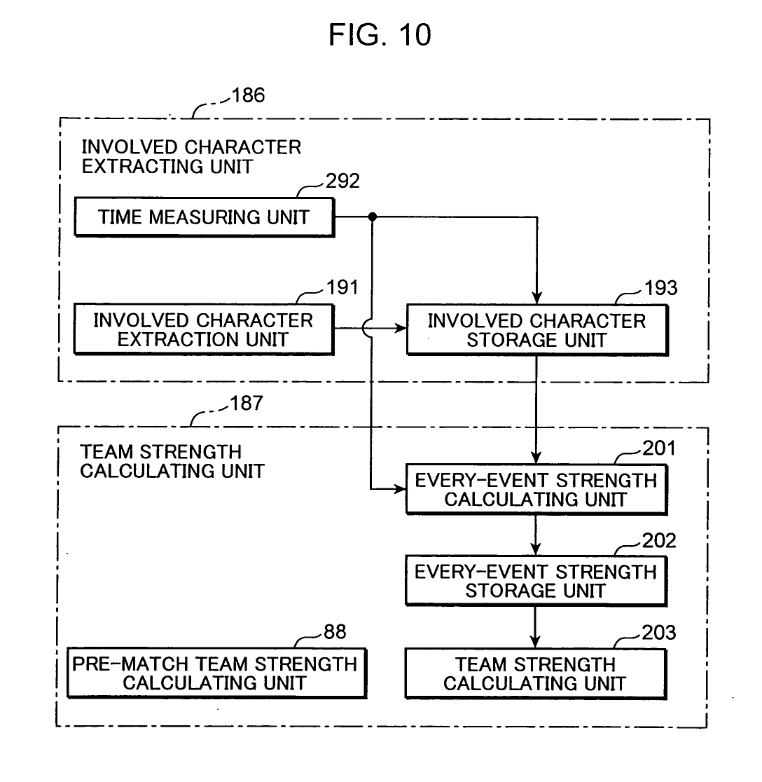

In the above description, the team strength value is finally calculated as an average value of the strength values in every specified event when the game ends while the characters involved in the actual match are extracted in every specified event constituting the match and the strength value is calculated in every specified event as needed. However, it is also possible to perform a similar process at every specified time interval which temporally divides the match. That is, the involved character extracting unit 186 may extract the player characters involved in the actual match at every specified time interval (e.g. every minute) which temporally divides the match and the team strength calculating unit 187 may calculate a strength value at every specified time interval based on the ability values of the characters extracted by the involved character extracting unit 186 and calculate the team strength value as an average value of the strength values at every specified time interval when the match ends. In this case, a time measuring unit 292 may be applied as shown in FIG. 10 instead of the event detecting unit 192 of FIG. 9 and a detection signal is output at regular time intervals as needed from the time measuring unit 292 from the start to the end of the match.

As described above, in the construction example of this embodiment, the player characters involved in the actual match are extracted in every specified event constituting the match or at every specified time interval that temporally divides the match, the strength value in every specified event or at every specified time interval is calculated as need based on the ability values of the extracted player characters, and the team strength value is calculated as an average value of the strength values in every specified event or at every specified time interval when the match ends. In this way, the player characters involved in the actual match are extracted little by little in every specified event constituting the match or at every specified time interval that temporally divides the match. Thus, the strength value calculated in every specified event or at every specified time interval truly reflects the real match facts. The team strength value calculated as the average value of the strength values calculated in every specified event or at every specified time interval truly reflects the real match facts of the entire match game. Further, since the strength value can be calculated in every specified event or at every specified time interval as needed during the match, an accurate team strength value can be quickly obtained after the end of the game.

### [Further Another Construction Example of the Game System]

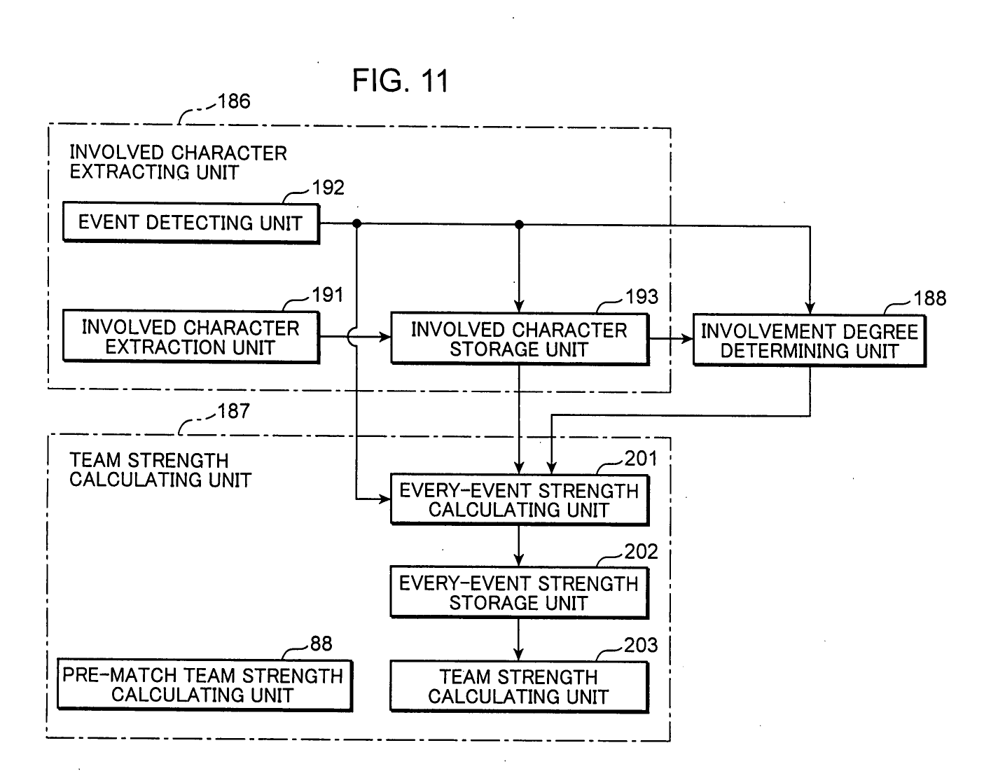

Next, a modification of the construction shown in FIG. 9 is described below with reference to a functional block diagram shown in FIG. 11. Note that elements similar to those shown in FIG. 9, etc. are identified by the same reference numerals and not described.

The degrees of involvement in the game of the respective player characters involved in the actual match differ. Thus, a construction example shown in FIG. 11 further includes an involvement degree determining unit 188 for determining a degree of involvement in the match of each player character extracted by the involved character extracting unit 186, and the team strength calculating unit 187 calculates a strength value in every specified event by increasing the weight of the ability value of each player character as the degree of involvement in the match of each player character determined by the involvement degree determining unit 188 increases and calculates a team strength value as an average value of the strength values in every specified event when the match ends. The other construction of the terminal unit is the same as that shown in FIG. 4 or 9 and the construction and operations of the server apparatus 103 are also as described above. Also here, every at-bat is described as an example of every specified event constituting the match.

In the construction example of FIG. 11, the event detecting unit 192 outputs a detection signal in every at-bat also to the involvement degree determining unit 188 as well as to the involved character storage unit 193 and the every-event strength calculating unit 201. Further, the involved character storage unit 193 outputs stored information on player characters involved in the match in one at-bat to the involvement degree determining unit 188 as well as to the every-event strength calculating unit 201 every time the detection signal is input from the event detecting unit 192.

The involvement degree determining unit 188 determines degrees of involvement in the match of the respective player characters actually involved in the match extracted by the involved character extracting unit 186 in every at-bat every time the detection signal is input from the event detecting unit 192.

An example of determining the degree of involvement of each player character in the involvement degree determining unit 188 is described below. Here, it is, for example, assumed that there was a hit over shortstop with a runner on the first base and the following respective player characters got involved in the play in this at-bat.

Defense side: pitcher character, catcher character, left fielder character, shortstop character, first baseman character, third baseman character

Offense side: batter character, runner character

In this case, on the defense side, the degrees of involvement in the play in this at-bat can be, for example, such that the pitcher character: 45%, the catcher character: 20%, the left fielder character: 20%, the shortstop character: 5%, the first baseman character: 5% and the third baseman character: 5%. Further, on the offense side, the degrees of involvement in the play in this at-bat can be, for example, such that the batter character: 70% and the runner character: 30% by additionally considering the running skill of the runner character.

These are merely examples and the degrees of involvement of the respective player characters actually involved in the match are determined according to various cases. For example, in the case of a strikeout with the bases empty, only the pitch character and the catcher character actually got involved in the match and the degrees of the defense side can be, for example, such that the pitcher character: 70% and the catcher character: 30%. The actually involved player characters further increase in number such as in the case of a double play with runner(s) on the base(s). Thus, the degrees of involvement of the respective player characters are individually determined in each scene. Further, the degrees of involvement of the respective player characters actually involved in the match on the offense side are determined, for example, such that the batter character: 100% with the bases empty; the batter character: 70% and each runner character: 15% with two runners on the bases, and the batter character 70% and each runner character: 10% with three runners on the bases (with the bases full). Specific numerical values of the degrees of involvement given here are only examples and may be other numerical values.

The involvement degree determining unit 188 may store a look-up table storing degrees of involvement (values corresponding to weights of weighted averages) in the match of the respective player characters actually involved in the match in correspondence with various cases, i.e. various combinations of the player characters extracted in every specified event (or at every specified time interval as described later) by the involved character extraction unit 191 in a specified storage area, and may be able to quickly determine the degree of involvement of each player character actually involved in the match based on this look-up table.

The every-event strength calculating unit 201 of the team strength calculating unit 187 calculates a strength value in every specified event (here, every at-bat) by increasing the weight of the ability value of each player character as the degree of involvement in the match of each player character determined by the involvement degree determining unit 188 increases.

For example, if the above at-bat where there was a hit over shortstop with a runner on the first base is assumed and the ability value of the pitcher character actually involved in the match is set at “14”, that of the catcher character at “12”, that of the left fielder character at “8”, that of the shortstop character at “6”, that of the first baseman character at “18” and that of the third baseman at “10”, the strength value of the defense side in this at-bat is “12.00” as shown in the following equation.

14×0.45+12×0.20+8×0.20+6×0.05+18×0.05+10×0.05=12.00

Further, if the ability value of the batter character is set at “15” and that of the runner character at “10”, a strength value of the offense side in this at-bat is “14.10” as shown in the following equation.

15×0.70+12×0.30=14.10

A strength value calculated in every specified event (here, in every at-bat) by the every-event strength calculating unit 201 of the team strength calculating unit 187 in this way is stored in the every-event strength storage unit 202 and a team strength value is calculated as an average value of the strength values in every specified event by the team strength calculating unit 203 when the match ends.

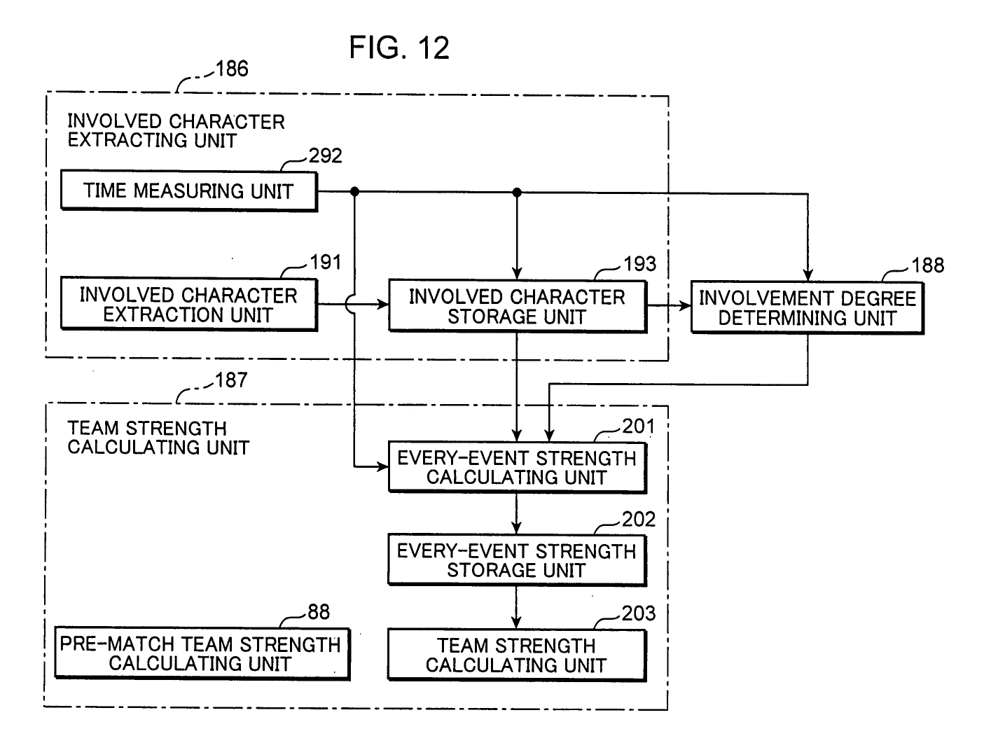

In the above description, the team strength value is finally calculated as an average value of the strength values in every specified event when the game ends while the characters involved in the actual match are extracted in every specified event constituting the match and the strength value in every specified event is calculated as needed. However, it is also possible to perform a similar process at every specified time interval which temporally divides the match. That is, the involved character extracting unit 186 may extract the player characters involved in the actual match at every specified time interval (e.g. every minute) which temporally divides the match and the team strength calculating unit 187 may calculate a strength value at every specified time interval based on the ability values of the characters extracted by the involved character extracting unit 186 and the degrees of involvement of the respective player characters determined by the involvement degree determining unit 188 and calculate the team strength value as an average value of the strength values at every specified time interval when the match ends. In this case, a time measuring unit 292 may be adopted as shown in FIG. 12 instead of the event detecting unit 192 of FIG. 11 and a detection signal is output at regular time intervals as needed from the time measuring unit 292 from the start to the end of the match.

As described above, in the construction example shown in FIG. 11 or 12, the player characters involved in the actual match are extracted little by little in every specified event constituting the match or at every specified time interval that temporally divides the match, and the strength value is calculated in every specified event or at every specified time interval while the degrees of involvement in the match of the respective extracted characters are calculated. Thus, the strength value calculated in every specified event or at every specified time interval truly reflects the real match facts. Further, since the strength value can be calculated in every specified event or at every specified time interval as needed during the match, an accurate team strength value can be quickly obtained after the end of the game.

### [Various Variations of the Game System]

In the network game system 100 according to this embodiment, various computer-readable programs to be implemented by the server apparatus 103 and the terminal units are stored in various computer-readable storage media such as a hard disk, an optical disk (CD-ROM, DVD-ROM, UMD, etc.), a flexible disk, a semiconductor memory, a ROM cassette and a cartridge for home video game machine, and are read into the server apparatus 103 and the terminal units to be implemented. Note that a means for providing various programs to the server apparatus 103 and the terminal units is not limited to the storage media described above and can be provided via the Internet 104. For example, if various programs can be downloaded via the Internet 104 from a homepage of a company managing the network game or the like, a game progress program and the like may be directly downloaded from this homepage and implemented.

Since the functions of the server apparatus 103 may be realized somewhere in the network game system 100 as described above, they may be realized as a plurality of functionally-distributed servers. Further, a system configuration is also possible in which one or more small-size computers in the network game system 100 serve some or all of the functions of the server apparatus 103.

Further, the terminal units in the network game system 100 may serve some of the functions of the server apparatus 103. For example, the server apparatus 103 includes the opponent team strength transmitting unit 73 (see FIG. 3) and transmits the team strength values of the opponents to the respective terminal units in the above embodiment. However, the respective terminal units may transmit the team strength values of their own to the opponents.

Although the respective terminal units calculate the team strength values of the own teams in the above embodiment, either one of the terminal units may calculate the team strength values of the both teams. In this case, the terminal unit that calculates the team strength values of the both teams needs to grasp the ability values of the characters of the both teams. Thus, the terminal unit that does not calculate the team strength values needs to transmit information on the ability values of the respective characters constituting the own team to the terminal unit that calculates the team strength values of the both teams. However, it is more preferable that the respective terminal units calculate the team strength values of the own teams as in the above embodiment since the function is distributed and a process load of one terminal unit needs not be increased.

The server apparatus 103 in the network game system 100 may serve some of the functions of the respective terminal units. For example, in the above embodiment, the respective terminal units calculate the team strength values of the own teams. However, the team strength values of the respective teams may be calculated in the server apparatus 103. In this case, the respective terminal units need to transmit information on the ability values of the respective characters constituting the own teams and extraction results of the player characters of the own teams involved in the actual match to the server apparatus 103. Concerning the transmission of the extraction results of the player characters of the own teams involved in the actual match to the server apparatus 103 by the respective terminal units, the respective terminal units can transmit the extraction results of the player characters during the regular communication since the two terminal units competing against each other are performing the regular communication (heartbeat transmission) with the server apparatus 103. Alternatively, the respective terminal units may store the extraction results of the player characters of the own teams until the end of the game and transmit them at once after the end of the game.

Methods for competing between the terminal units operated by the respective players include a method for competing through direct communication between the terminal units and a method for competing via the server apparatus 103. Although the network game system for executing a network game by the former method, i.e. by P2P connection to directly transfer data between the terminal units is described in the above embodiment, the latter method, i.e. a method for executing a network game by so-called client/server (C/S) connection so that the terminal units as clients compete via the server apparatus 103 may be adopted. Since the server apparatus 103 manages various data during the match adopting the C/S connection method, it can be easily realized to provide the server apparatus 103 with the involved character extracting unit 86, 186, the team strength calculating unit 87, 187, the involvement degree calculating unit 98 and the involvement degree determining unit 188.

A privilege is basically granted when a team having a lower team strength value than the opponent wins a match. However, if team strength values differ to a certain extent, a team having a lower team strength value made very strenuous efforts, considering the difference between the team strength values, even if this team actually lost by a narrow margin, wherefore a privilege may be granted to the team having the lower team strength value. Accordingly, a handicap value may be set according to a difference between team strength values of both teams, and a privilege may be granted to the player of the team having the lower team strength value and having actually lost in the case where this team would have won if a score had been calculated taking this handicap value into consideration even though this team actually lost the match.

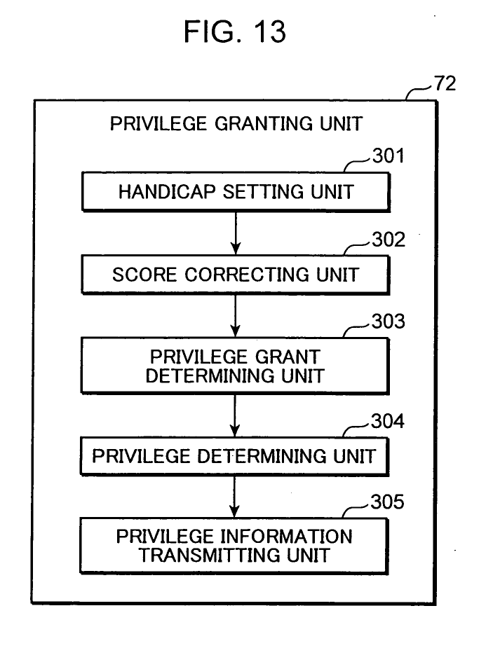

A construction example of the privilege granting unit 72 for realizing this is shown in FIG. 13. As shown in FIG. 13, the privilege granting unit 72 includes a handicap setting unit 301, a score correcting unit 302, a privilege grant determining unit 303, a privilege determining unit 304 and a privilege information transmitting unit 305.

The handicap setting unit 301 sets a handicap value corresponding to a difference between team strength values of teams having competed against each other if a team having a lower team strength value than the opponent lost a match. For example, if Twin denotes the team strength value of the winning team, Tlost denotes that of the losing team and H denotes the handicap value, the handicap setting unit 301 sets the handicap value H calculated by H=Twin−Tlost.

The score correcting unit 302 corrects a score as a match result to the advantage of the team having the lower team strength value based on the above handicap value. For example, if Swin denotes a score of the winning team, Slost denotes that of the losing team and Slost′ denotes a corrected score of the losing team taking the handicap value H into consideration, the score correcting unit 302 performs a calculation of Slost′=Slost+H and corrects the score of the losing team to Slost′. Alternatively, the score correcting unit 302 performs a calculation of Swin′=Slost−H and corrects the score of the winning team to Swin′.

The privilege grant determining unit 303 determines the grant of a privilege to the losing team if the corrected score Slost′ of the losing team>the score Swin of the winning team or the score Slost of the losing team>the corrected score Swin′ of the winning team after the score correction by the score correcting unit 302.

The privilege determining unit 304 determines a privilege to be granted not only when the team having the lower team strength value than the opponent won the match, but also when the privilege grant determining unit 303 determines to grant the privilege to the losing team. However, when the team having the lower team strength value than the opponent actually lost, but was regarded to have won in consideration of the handicap value, the attainable privilege is made less than when this team won without the handicap value. As an example of making the privilege less in this case, it is thought to adjust bonus points by reducing the base points from 300 to 100 when the above equation (1) or (2) is applied.

The privilege information transmitting unit 305 transmits the privilege information determined by the privilege determining unit 304 to the terminal unit to which the privilege is to be granted.

For example, it is assumed that a team A of the terminal unit A operated by a first player and a team B of the terminal unit B operated by a second player competed, a team strength value of the team A was “14” and that of the team B was “16”. It is further assumed that the team A lost against the team B by a score of “4−5” as a result a match of the both teams. In this case, a handicap value H=16−14=2. Thus, if the score is corrected in consideration of the handicap value H=2, the corrected score of the losing team A is 4+2=6 points and the team A is regarded to have won against the team B by a score of “6−5” after the score correction. Therefore, in this case, a privilege is granted to the first player of the team A that actually lost.

In this way, even if a team played well, but eventually lost a match because having a lower team strength value calculated from ability values of characters actually involved in the match than the opponent, a privilege is granted if this team is regarded to have won, taking a handicap value corresponding to a difference between the team strength values of the both teams into consideration. Thus, a player who competed against a substantially stronger team can feel convinced. Further, even if a team is losing a game by being matched up with a substantially stronger team, concentration on the game can be aroused despite the losing game since the team obtains a chance to attain a privilege if playing well, wherefore a game which strongly attracts players into a virtual space can be realized.

Although an example in which teams of two players compete one-on-one is illustrated in the above embodiment, application to a network game in which teams of three or more players compete is also possible. A difference between team strength values when the teams of three or more players compete may be a difference between the team strength values of arbitrary two teams included in a plurality of completing teams.

Although the baseball game is described as an example of the network game in the above embodiment, an applicable network game is not limited to this. Application to various games is possible provided that these games are network games in which teams of players compete. For example, similar application to various sports games such as soccer games, American football games and volleyball games, simulation games, shooting games, roll playing games and the like is possible.

Technical features of the above game system are summarized as follows.

(1) A game system according to one aspect of the present invention is for executing a team match game in which players respectively operating a plurality of terminal units compete by maneuvering characters constituting own teams and includes an involved character extracting unit for extracting characters involved in an actual match during the match; a team strength calculating unit for calculating a team strength value indicating a strength level of each team for each team based on ability values of the characters extracted by the involved character extracting unit; a strength difference calculating unit for calculating a difference between the team strength values of the respective teams calculated by the team strength calculating unit; and a privilege granting unit for granting a privilege corresponding to the difference between the team strength values calculated by the strength difference calculating unit to the winning team when the team having a lower team strength value than the opponent wins the match.

When playing the team match game, the players do not necessary use all the characters constituting the own teams in the actual match. For instance, in a baseball game as an example, there can be substitute characters which do not get involved in the match at all just by sitting on the bench. The strength level of the team including such characters which do not get involved in the actual match deviates from the strength of the team in the real match. Accordingly, in the game system of the present invention, the characters involved in the actual match during the match are extracted by the involved character extracting unit and the team strength values indicating the strength levels of the respective teams are calculated based on the ability values of the extracted characters by the team strength calculating unit. In this way, the team strength values corresponding to the real match can be calculated by excluding the characters not involved in the actual match.

Further, it has caused a sense of injustice among players that the levels of player characters largely differ in an actual match although the system matches opponents having comparable team levels in pre-match matching. Accordingly, the game system of the present invention is so constructed that the privilege granting unit grants the privilege corresponding to the difference between the team strength values calculated by the strength difference calculating unit to the winning team when the team having a lower team strength value than the opponent nevertheless wins the match. Therefore, a sense of injustice is resolved and a more interesting and enjoyable team match game can be realized.

Particularly, in the game system of the present invention, the team strength values calculated based only on the player characters actually involved in the match are used for level comparison between the two teams having competed against each other, and the privilege is granted according to the difference between the team strength values. Thus, the strength of the opponent team against which the player actually played can be truly reflected on the privilege. Accordingly, the player can confirm that a higher privilege is granted when winning the opponent he actually felt strong during the game and, hence, can feel sufficiently convinced. Further, since the player obtains a chance to attain a higher privilege when the opponent is substantially stronger, concentration on the match to attain a higher privilege is aroused. Therefore, a game which strongly attracts players into a virtual space can be realized.

(2) In the above construction, it is preferable that the game system further includes an involvement degree calculating unit for calculating a degree of involvement in the match of each character extracted by the involved character extracting unit; and that the team strength calculating unit calculates the team strength value by increasing a weight of the ability value of each character as the degree of involvement in the match of each character calculated by the involvement degree calculating unit increases.

Since the degrees of involvement in the game of the respective characters involved in the actual match differ, the degrees of involvement in the match of the respective characters extracted as the characters involved in the actual match are calculated and the team strength values are calculated by increasing the weight of the ability value of each character as the degree of involvement in the match increases in the above construction. Here, a high degree of involvement in the match indicates a degree of influence on a match result such as a degree of importance of a role in the match and time and frequency involved in the match. Specifically, for example, in the case of a defense side of a baseball game, a pitcher and a catcher have more influence on defense and, hence, have higher degrees of involvement in the match than other fielders. Further, in the case of offense, a degree of involvement in a match is higher for a player who gets to bat throughout the entire match, e.g. gets to bat four times than for a player who gets to bat as a pinch hitter if the number of at-bats is focused. In a soccer game, for example, a captain has a higher degree of involvement in a match than other players. In this way, the team strength values reflecting also degrees of involvement in the match of the respective characters involved in the actual match are obtained, thereby enabling a team level comparison of the both teams truly reflecting real match facts. Since the privilege is granted according to the difference between these team strength values, the strength of the opponent team against which the player actually played is truly reflected on the privilege.

(3) In the above construction, it is preferable that the involved character extracting unit separately extracts characters involved in the actual match at the time of offense and at the time of defense during the match; that the involvement degree calculating unit separately calculates degrees of involvement of the respective characters in offence and those of the respective characters in defense; and that the team strength calculating unit calculates offensive team strength values based on the ability values of the respective characters at the time of offense and the degrees of involvement thereof in offense, calculates defensive team strength values based on the ability values of the respective characters at the time of defense and the degrees of involvement thereof in defense and calculates the team strength values by adding or averaging the offensive team strength values and the defensive team strength values.

According to the above construction, the characters involved in the actual match are separately extracted and the degrees of involvement thereof are separately calculated at the time of offense and at the time of defense during the match. Further, different ability values are given for the ability values of the respective characters at the time of offense and at the time of defense. The team strength calculating unit calculates the offensive team strength values and the defensive team strength values and obtains the team strength values by adding or averaging these. Also in a real world, an offensive skill and a defensive skill are not necessarily equal such as when a certain player has an ordinary defensive skill, but is excellent in running skill such as base stealing (i.e. offensive ability) or conversely is poor in hitting skill (e.g. offensive ability), but is excellent in defensive skill, for example, in the case of baseball. In this respect, according to this construction, the team strength values accurately reflecting the offensive skills (ability values at the time of offense) and the defensive skills (ability values at the time of defense) of the respective characters can be calculated.

(4) In the above construction, it is preferable that the involved character extracting unit extracts characters involved in the actual match in every specified event constituting the match or at every specified time interval that temporally divides the match; and that the team strength calculating unit calculates strength values in every specified event or at every specified time interval based on the ability values of the characters extracted by the involved character extracting unit and calculates the team strength values as average values of the strength values in every specified event or at every specified time interval when the match ends.

According to the above construction, since the characters involved in the actual match are extracted little by little in every specified event constituting the match or at every specified time interval that temporally divides the match, the strength values calculated in every specified event or at every specified time interval truly reflect real match facts. The team strength values calculated as the average values of the strength values calculated in every specified event or at every specified time interval truly reflect the real match facts in the entire game of the match. For example, in the case of baseball, it seldom occurs that a starting lineup remains unchanged to the end of a game and players are relatively frequently replaced such as pitching change, pinch hit and pinch run. That is, a strength value of the team is changed every time such an action is made. According to this construction, such variations of team strengths seen also in the real world can be truly reflected. Further, since the strength values can be calculated in every specified event or at every specified time interval as needed, accurate team strength values can be quickly obtained after the end of the game.

(5) In the above construction, it is preferable that the game system further includes an involvement degree determining unit for determining degrees of involvement in the match of the respective characters extracted in every specified event or at every specified time interval by the involved character extracting unit; and that the team strength calculating unit calculates the team strength values in every specified event or at every specified time interval by increasing weights of the ability values of the respective characters as the degrees of involvement in the match of the respective characters determined by the involvement degree determining unit increase.

According to the above construction, the characters involved in the actual match are extracted little by little in every specified event constituting the match or at every specified time interval that temporally divides the match, the degrees of involvement in the match of the respective extracted characters are also calculated and the strength values are calculated in every specified event or at every specified time interval. Thus, the degrees of involvement in the match of the respective characters involved in the actual match are also reflected on the strength values calculated in every specified event or at every specified time interval, wherefore the strength values more truly reflecting the real match facts can be calculated.

(6) In the above construction, the involvement degree determining unit preferably includes a look-up table storing degrees of involvement in the match of the respective characters in correspondence with combinations of characters extracted in every specified event or at every specified time interval by the involved character extracting unit and determines the degrees of involvement of the respective characters based on the look-up table.

According to the above construction, since the look-up table storing the degrees of involvement in the match of the respective characters in correspondence with the combinations of the characters extracted in every specified event or at every specified time interval is prepared, the degrees of involvement in the match of the respective characters can be quickly determined by reference to this look-up table.

(7) In the above construction, the privilege granting unit preferably grants a higher privilege to the winning team for a larger score spread of a match result when the team having a lower team strength value than the opponent wins the match.

According to the above construction, since the privilege to be granted changes according to the score spread of the match result, the players try not only to merely win, but also to win by scoring more to attain a higher privilege. Thus, more concentration on the game is aroused and a more integrating and enjoyable game can be realized.

(8) In the above construction, it is preferable that the privilege granting unit includes a handicap setting unit for setting a handicap value corresponding to a difference between the team strength values of the teams having competed against each other when the team having a lower team strength value than the opponent loses the match, a score correcting unit for correcting scores of the respective teams as the match result to the advantage of the team having the lower team strength value based on the handicap value, and a privilege grant determining unit for judging whether or not a privilege is to be granted based on the scores of the respective teams corrected by the score correcting unit; and that the privilege grant determining unit judges to grant a privilege to the team having the lower team strength value when the score of the team having the lower team strength value becomes higher than that of the opponent team by the score correction by the score correcting unit.

The privilege is basically granted by the privilege granting unit when a team having a lower team strength value than the opponent wins a match. If team strength values differ to a certain extent, a team having a lower team strength value made very strenuous efforts, considering the difference between the team strength values, even if this team actually lost by a narrow margin. Thus, the team having the lower team strength value may deserve the grant of a privilege. Accordingly, as in the above construction, a handicap value is set according to a difference between team strength values, and a privilege is granted to a player of a team having a lower team strength value and having actually lost in the case where this team would have won if a score had been calculated taking this handicap value into consideration even though this team actually lost the match. This enables the player having competed against the substantially stronger team to feel convinced since the privilege can be attained if the team plays well although actually losing the match. Further, even if a team is losing a game by being matched up with a substantially stronger team, the team obtains a chance to attain a privilege if playing well. Therefore, concentration on the game can be aroused despite the losing game, wherefore a game which strongly attracts players into a virtual space can be realized.

This application is based on Japanese Patent Application Serial No. 2010-177285 filed with Japan Patent Office on Aug. 6, 2010, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A game system for executing a team match game in which players respectively operating a plurality of terminal units compete by maneuvering characters constituting own teams, comprising:
an involved character extracting unit for extracting characters involved in an actual match during the match;
a team strength calculating unit for calculating a team strength value indicating a strength level of each team for each team based on ability values of the characters extracted by the involved character extracting unit;
a strength difference calculating unit for calculating a difference between the team strength values of the respective teams calculated by the team strength calculating unit; and
a privilege granting unit for granting a privilege corresponding to the difference between the team strength values calculated by the strength difference calculating unit to the winning team when the team having a lower team strength value than the opponent wins the match.

2. A game system according to claim 1, further comprising an involvement degree calculating unit for calculating a degree of involvement in the match of each character extracted by the involved character extracting unit, wherein:
the team strength calculating unit calculates the team strength value by increasing a weight of the ability value of each character as the degree of involvement in the match of each character calculated by the involvement degree calculating unit increases.

3. A game system according to claim 2, wherein:
the involved character extracting unit separately extracts characters involved in the actual match at the time of offense and at the time of defense during the match;
the involvement degree calculating unit separately calculates degrees of involvement of the respective characters in offence and those of the respective characters in defense; and
the team strength calculating unit calculates offensive team strength values based on the ability values of the respective characters at the time of offense and the degrees of involvement thereof in offense, calculates defensive team strength values based on the ability values of the respective characters at the time of defense and the degrees of involvement thereof in defense and calculates the team strength values by adding or averaging the offensive team strength values and the defensive team strength values.

4. A game system according to claim 1, wherein:
the involved character extracting unit extracts characters involved in the actual match in every specified event constituting the match or at every specified time interval that temporally divides the match; and
the team strength calculating unit calculates strength values in every specified event or at every specified time interval based on the ability values of the characters extracted by the involved character extracting unit and calculates the team strength values as average values of the strength values in every specified event or at every specified time interval when the match ends.

5. A game system according to claim 4, further comprising an involvement degree determining unit for determining degrees of involvement in the match of the respective characters extracted in every specified event or at every specified time interval by the involved character extracting unit, wherein:
the team strength calculating unit calculates the team strength values in every specified event or at every specified time interval by increasing weights of the ability values of the respective characters as the degrees of involvement in the match of the respective characters determined by the involvement degree determining unit increase.

6. A game system according to claim 5, wherein the involvement degree determining unit includes a look-up table storing degrees of involvement in the match of the respective characters in correspondence with combinations of characters extracted in every specified event or at every specified time interval by the involved character extracting unit and determines the degrees of involvement of the respective characters based on the look-up table.

7. A game system according to claim 1, wherein the privilege granting unit grants a higher privilege to the winning team for a larger score spread of a match result when the team having a lower team strength value than the opponent wins the match.

8. A game system according to claim 1, wherein:
the privilege granting unit includes:
a handicap setting unit for setting a handicap value corresponding to a difference between the team strength values of the teams having competed against each other when the team having a lower team strength value than the opponent loses the match;
a score correcting unit for correcting scores of the respective teams as the match result to the advantage of the team having the lower team strength value based on the handicap value; and
a privilege grant determining unit for judging whether or not a privilege is to be granted based on the scores of the respective teams corrected by the score correcting unit; and
the privilege grant determining unit judges to grant a privilege to the team having the lower team strength value when the score of the team having the lower team strength value becomes higher than that of the opponent team by the score correction by the score correcting unit.

9. A method for controlling a game system for executing a team match game in which players respectively operating a plurality of terminal units compete by maneuvering characters constituting own teams, comprising:
an involved character extracting step in which the game system extracts characters involved in an actual match during the match;
a team strength calculating step in which the game system calculates a team strength value indicating a strength level of each team for each team based on ability values of the characters extracted in the involved character extracting step;
a strength difference calculating step in which the game system calculates a difference between the team strength values of the respective teams calculated in the team strength calculating step; and
a privilege granting step in which the game system grants a privilege corresponding to the difference between the team strength values calculated in the strength difference calculating step to the winning team when the team having a lower team strength value than the opponent wins the match.

10. A computer-readable storage medium storing a program for causing a computer included in a game system for executing a team match game in which players respectively operating a plurality of terminal units compete by maneuvering characters constituting own teams to realize:
an involved character extracting function of extracting characters involved in an actual match during the match;
a team strength calculating function of calculating a team strength value indicating a strength level of each team for each team based on ability values of the characters extracted by the involved character extracting function;
a strength difference calculating function of calculating a difference between the team strength values of the respective teams calculated by the team strength calculating function; and
a privilege granting function of granting a privilege corresponding to the difference between the team strength values calculated by the strength difference calculating function to the winning team when the team having a lower team strength value than the opponent wins the match.
